(19) United States
(12) Patent Application Publication
(10) Pub. No.: US 2009/0216821 A1
(43) Pub. Date: Aug. 27, 2009

(54) Singular Value Decomposition Apparatus and Singular Value Decomposition Method

(75) Inventors: Yoshimasa Nakamura, Kyoto (JP); Taro Konda, Kyoto (JP); Masashi Iwasaki, Kyoto (JP); Shinya Sakano, Kyoto (JP); Masami Takata, Kyoto (JP)

Correspondence Address: RADER FISHMAN & GRAUER PLLC, LION BUILDING, 1233 20TH STREET N.W., SUITE 501, WASHINGTON, DC, 20036, US

(73) Assignee: KYOTO UNIVERSITY, Kyoto (JP)

(21) Appl. No.: 12/086,013

(22) PCT Filed: Sep. 21, 2006
(86) PCT No.: PCT/JP2006/318713

§ 371 Date: Feb. 10, 2009

(30) Foreign Application Priority Data
Dec. 5, 2005 (JP) 2005-351089

(51) Int. Cl. G06F 17/12

(52) U.S. Cl. 708/446

(57) ABSTRACT

The present invention provides a singular value decomposition apparatus that can perform processing in parallel at high speed and high accuracy. The singular value decomposition apparatus comprises a matrix dividing portion 14 that repeatedly divides a bidiagonal matrix B into two bidiagonal matrices, a singular value decomposition portion 15 that performs singular value decomposition on the bidiagonal matrices after the division, a singular value computing portion 17 that repeatedly computes singular values of the bidiagonal matrix that is the division origin and matrix elements of the bidiagonal matrix that is the division origin based on singular values and matrix elements, which are a part of elements of left and right orthogonal matrices constituted by singular vectors, the singular values and the singular vectors being obtained by the singular value decomposition portion 15 performing singular value decomposition, until a singular value of the bidiagonal matrix B is computed, and a singular vector computing portion 19 that computes a singular vector of the bidiagonal matrix B based on the bidiagonal matrix B and the singular value thereof using twisted factorization.

### TECHNICAL FIELD

The present invention relates to singular value decomposition apparatuses and the like for performing singular value decomposition.

### BACKGROUND ART

Singular value decomposition (SVD) is applied to many fields such as image processing and data search as a main matrix operation of data processing.

For example, Non-Patent Document 1 below is known as a conventional example of singular value decomposition.

### [Non-Patent Document 1] Ming Gu and Stanley C. Eisenstat, “A Divide-and-Conquer Algorithm for the Bidiagonal SVD”, SIAM Journal on Matrix Analysis and Applications, Vol. 16, No. 1, pp. 79-92, (1995)

### DISCLOSURE OF INVENTION

### Problems to be solved by the Invention

Recently, in accordance with an increase in data size and the like in these application fields, singular value decomposition at high speed and high accuracy is required. Furthermore, there has been a demand for development of a singular value decomposition apparatus and the like capable of performing parallel processing of singular value decomposition.

The present invention was arrived at in view of these circumstances, and it is an object thereof to provide a singular value decomposition apparatus and the like capable of performing singular value decomposition with excellent parallelism, and at high speed and high accuracy.

### Means for Solving the Problems

In order to achieve the above-described object, the present invention is directed to a singular value decomposition apparatus, comprising: a diagonal matrix storage portion in which a bidiagonal matrix B is stored; a singular value decomposition storage portion in which singular values of each of bidiagonal matrices and matrix elements, which are a part of elements of left and right orthogonal matrices constituted by singular vectors of each of the bidiagonal matrices, are stored, the singular values and the singular vectors being obtained by dividing the bidiagonal matrix B into two bidiagonal matrices, repeating the process of dividing the bidiagonal matrix into two bidiagonal matrices until the size of each of the bidiagonal matrices after the division becomes not greater than a predetermined size, and performing singular value decomposition on each of the bidiagonal matrices whose size is not greater than the predetermined size; a singular value storage portion in which a singular value of the bidiagonal matrix B is stored; a singular value computing portion that reads out the singular values and the matrix elements of each of the bidiagonal matrices from the singular value decomposition storage portion, computes singular values of the bidiagonal matrix that is the division origin and matrix elements of the bidiagonal matrix that is the division origin based on the singular values and the matrix elements and stores the computed singular values and matrix elements in the singular value decomposition storage portion, repeats the process of computing singular values and matrix elements of the bidiagonal matrix that is the division origin, until at least one singular value of the bidiagonal matrix B is computed, and stores the at least one singular value of the bidiagonal matrix B in the singular value storage portion; a singular vector storage portion in which a singular vector of the bidiagonal matrix B is stored; and a singular vector computing portion that reads out the bidiagonal matrix B from the diagonal matrix storage portion, reads out the singular value of the bidiagonal matrix B from the singular value storage portion, computes at least one singular vector of the bidiagonal matrix B based on the bidiagonal matrix B and the singular value thereof using twisted factorization, and stores the computed singular vector in the singular vector storage portion.

With this configuration, it is possible to realize singular value decomposition at high speed and high accuracy, by computing a singular value first, and then computing a singular vector based on the singular value using twisted factorization. Furthermore, this singular value decomposition is excellent also in parallelism.

Furthermore, the singular value decomposition apparatus according to the present invention may be configured such that each of the bidiagonal matrices whose size is not greater than the predetermined size is also stored in the diagonal matrix storage portion, and the singular value decomposition apparatus further comprises a singular value decomposition portion that reads out each of the bidiagonal matrices whose size is not greater than the predetermined size from the diagonal matrix storage portion, performs singular value decomposition on each of the bidiagonal matrices so as to compute singular values of each of the bidiagonal matrices and singular vectors of each of the bidiagonal matrices, and stores the singular values and matrix elements, which are a part of elements of left and right orthogonal matrices constituted by the singular vectors, in the singular value decomposition storage portion.

With this configuration, in computation of singular values, it is possible to perform singular value decomposition on each of the bidiagonal matrices whose size is not greater than the predetermined size, in the singular value decomposition apparatus.

Moreover, the present invention is directed to a singular value decomposition apparatus, comprising: a diagonal matrix storage portion in which a bidiagonal matrix B is stored; a matrix dividing portion that reads out the bidiagonal matrix B from the diagonal matrix storage portion, divides the bidiagonal matrix B into two bidiagonal matrices and stores the two bidiagonal matrices in the diagonal matrix storage portion, and repeats the process of dividing the bidiagonal matrix into two bidiagonal matrices and storing the two bidiagonal matrices in the diagonal matrix storage portion until the size of each of the bidiagonal matrices after the division becomes not greater than a predetermined size; a singular value decomposition portion that reads out each of the bidiagonal matrices whose size is not greater than the predetermined size from the diagonal matrix storage portion, and performs singular value decomposition on each of the bidiagonal matrices so as to compute singular values of each of the bidiagonal matrices and singular vectors of each of the bidiagonal matrices; a singular value decomposition storage portion in which the singular values and matrix elements, which are a part of elements of left and right orthogonal matrices constituted by the singular vectors, are stored, the singular values and the singular vectors being obtained by the singular value decomposition portion performing singular value decomposition; a singular value storage portion in which a singular value of the bidiagonal matrix B is stored; a singular value computing portion that reads out the singular values and the matrix elements of each of the bidiagonal matrices from the singular value decomposition storage portion, computes singular values of the bidiagonal matrix that is the division origin and matrix elements of the bidiagonal matrix that is the division origin based on the singular values and the matrix elements and stores the computed singular values and matrix elements in the singular value decomposition storage portion, repeats the process of computing singular values and matrix elements of the bidiagonal matrix that is the division origin, until at least one singular value of the bidiagonal matrix B is computed, and stores the at least one singular value of the bidiagonal matrix B in the singular value storage portion; a singular vector storage portion in which a singular vector of the bidiagonal matrix B is stored; and a singular vector computing portion that reads out the bidiagonal matrix B from the diagonal matrix storage portion, reads out the singular value of the bidiagonal matrix B from the singular value storage portion, computes at least one singular vector of the bidiagonal matrix B based on the bidiagonal matrix B and the singular value thereof using twisted factorization, and stores the computed singular vector in the singular vector storage portion.

With this configuration, it is possible to realize singular value decomposition at high speed and high accuracy, by computing a singular value first, and then computing a singular vector based on the singular value using twisted factorization. Furthermore, this singular value decomposition is excellent also in parallelism. Moreover, if all singular values or singular vectors do not have to be computed, only necessary singular values or singular vectors can be computed, and thus the processing load can be reduced.

Furthermore, the singular value decomposition apparatus according to the present invention may be configured such that the singular vector computing portion computes a singular vector using qd-type twisted factorization.

With this configuration, it is possible to realize singular value decomposition at high speed and high accuracy. Furthermore, this singular value decomposition is excellent also in parallelism.

Furthermore, the singular value decomposition apparatus according to the present invention may be configured such that the singular vector computing portion computes a singular vector using LV-type twisted factorization.

With this configuration, it is possible to compute a singular vector in a numerically stable manner.

Furthermore, the singular value decomposition apparatus according to the present invention may be configured such that the singular vector computing portion further comprises: a Cholesky decomposition portion that reads out the bidiagonal matrix B from the diagonal matrix storage portion, reads out the singular value of the bidiagonal matrix B from the singular value storage portion, and performs Cholesky decomposition on the bidiagonal matrix B into an upper bidiagonal matrix B⁽⁺¹⁾ and a lower bidiagonal matrix B⁽⁻¹⁾ by performing Miura transformation, dLVv-type transformation, and inverse Miura transformation on each element of the bidiagonal matrix B; a first singular vector computing portion that computes a singular vector constituting one of left and right orthogonal matrices, using each element of the upper bidiagonal matrix B⁽⁺¹⁾ and the lower bidiagonal matrix B⁽⁻¹⁾ and the singular value of the bidiagonal matrix B, and stores the computed singular vector in the singular vector storage portion; and a second singular vector computing portion that computes a singular vector constituting the other of the left and right orthogonal matrices, using the singular vector constituting one of the left and right orthogonal matrices computed by the first singular vector computing portion, the singular value of the bidiagonal matrix B, and the bidiagonal matrix B, and stores the computed singular vector in the singular vector storage portion.

With this configuration, it is possible to compute a singular vector in a numerically stable manner, by using multiple auxiliary variables in the process of Cholesky decomposition.

Furthermore, the singular value decomposition apparatus according to the present invention may be configured such that the Cholesky decomposition portion comprises multiple Cholesky decomposition units, and the multiple Cholesky decomposition units perform, in parallel, the process of performing Cholesky decomposition on the bidiagonal matrix B.

With this configuration, it is possible to perform the process of Cholesky decomposition in a short time.

Furthermore, the singular value decomposition apparatus according to the present invention may be configured such that the first singular vector computing portion comprises multiple first singular vector computing units, and the multiple first singular vector computing units perform, in parallel, the process of computing a singular vector.

With this configuration, it is possible to perform the process of computing a singular vector in a short time.

Furthermore, the singular value decomposition apparatus according to the present invention may be configured such that the second singular vector computing portion comprises multiple second singular vector computing units, and the multiple second singular vector computing units perform, in parallel, the process of computing a singular vector.

With this configuration, it is possible to perform the process of computing a singular vector in a short time.

Furthermore, the singular value decomposition apparatus according to the present invention may be configured such that the singular value computing portion comprises multiple singular value computing units, and the multiple singular value computing units perform, in parallel, the process of computing singular values and matrix elements of a bidiagonal matrix that is a division origin.

With this configuration, it is possible to perform the process of computing a singular value in a short time.

Furthermore, the singular value decomposition apparatus according to the present invention may be configured such that the singular value decomposition portion comprises multiple singular value decomposition units, and the multiple singular value decomposition units perform, in parallel, the process of performing singular value decomposition on a bidiagonal matrix.

With this configuration, it is possible to perform the process of singular value decomposition in a short time.

Furthermore, the singular value decomposition apparatus according to the present invention may further comprise: a matrix storage portion in which a matrix A is stored; and a diagonalization portion that reads out the matrix A from the matrix storage portion, computes the bidiagonal matrix B in which the matrix A is bidiagonalized, and stores the bidiagonal matrix B in the diagonal matrix storage portion.

With this configuration, it is possible to compute a singular value of an arbitrary matrix A. Furthermore, it is also possible to compute a singular vector of the matrix A, by using the singular vector of the bidiagonal matrix B.

Furthermore, the singular value decomposition apparatus according to the present invention may be configured such that the matrix dividing portion divides a bidiagonal matrix into two substantially half bidiagonal matrices.

With this configuration, it is possible to perform parallel processing as appropriate.

### EFFECT OF THE INVENTION

With the singular value decomposition apparatus and the like according to the present invention, singular value decomposition can be performed at high speed and high accuracy. Furthermore, the singular value decomposition apparatus and the like are excellent also in parallelism.

### BEST MODE FOR CARRYING OUT THE INVENTION

Hereinafter, a singular value decomposition apparatus according to the present invention will be described by way of embodiments. It should be noted that the same or corresponding constituent elements and steps are denoted by the same reference numerals in the following embodiments, and a description thereof may not be repeated.

### Embodiment 1

Hereinafter, a singular value decomposition apparatus according to Embodiment 1 of the present invention will be described with reference to the drawings.

FIG. 1 is a block diagram showing the configuration of a singular value decomposition apparatus 1 according to this embodiment. In FIG. 1, the singular value decomposition apparatus 1 according to this embodiment includes a matrix storage portion 11, a diagonalization portion 12, a diagonal matrix storage portion 13, a matrix dividing portion 14, a singular value decomposition portion 15, a singular value decomposition storage portion 16, a singular value computing portion 17, a singular value storage portion 18, a singular vector computing portion 19, and a singular vector storage portion 20.

In the matrix storage portion 11, an arbitrary matrix A is stored. This matrix A is a real matrix in which each element is a real number. Herein, the phrase ‘matrix A is stored’ refers to a state in which data representing the matrix A is stored. The same is applied to storage portions described below. The matrix storage portion 11 can be realized as a given storage medium (e.g., a semiconductor memory, a magnetic disk, an optical disk, etc.). In the matrix storage portion 11, data may be temporarily stored in a RAM or the like, or may be stored for a long time. There is no limitation on the procedure in which the matrix A is stored in the matrix storage portion 11. For example, the matrix A may be stored via a storage medium in the matrix storage portion 11, the matrix A transmitted via a communication line or the like may be stored in the matrix storage portion 11, or the matrix A input via an input device such as a keyboard or a mouse may be stored in the matrix storage portion 11.

The diagonalization portion 12 reads out the matrix A from the matrix storage portion 11, and computes a bidiagonal matrix B in which the read matrix A is bidiagonalized. Then, the diagonalization portion 12 stores the computed bidiagonal matrix B in the diagonal matrix storage portion 13. The diagonalization portion 12 bidiagonalizes the matrix A, for example, by repeating Householder transformation as many times as necessary, or using other bidiagonalization methods. Herein, the bidiagonal matrix B may be an upper bidiagonal matrix, or may be a lower bidiagonal matrix. In this embodiment, a case will be described in which the bidiagonal matrix B is an upper bidiagonal matrix.

In the diagonal matrix storage portion 13, the bidiagonal matrix B is stored. The diagonal matrix storage portion 13 can be realized as a given storage medium (e.g., a semiconductor memory, a magnetic disk, an optical disk, etc.). In the diagonal matrix storage portion 13, data may be temporarily stored in a RAM or the like, or may be stored for a long time.

The matrix dividing portion 14 reads out the bidiagonal matrix B from the diagonal matrix storage portion 13, divides the bidiagonal matrix B into two bidiagonal matrices, and stores the bidiagonal matrices in the diagonal matrix storage portion 13. The matrix dividing portion 14 recursively repeats the process of dividing the bidiagonal matrix into two bidiagonal matrices and storing the bidiagonal matrices in the diagonal matrix storage portion 13 until the size of each of the bidiagonal matrices after the division becomes equal to or smaller than a predetermined size.

The singular value decomposition portion 15 reads out each of the bidiagonal matrices whose size is equal to or smaller than the predetermined size from the diagonal matrix storage portion 13, and performs singular value decomposition on each of the bidiagonal matrices so as to compute singular values of each of the bidiagonal matrices and singular vectors of each of the bidiagonal matrices. The singular value decomposition portion 15 may perform singular value decomposition, for example, using bisection and inverse iteration in combination, MR̂3, QRs, or the like. Herein, in MR̂3, singular values may be computed, for example, using qds such as dqds or pqds. Furthermore, if singular value decomposition is performed using QRs, DBDSQR provided in FORTRAN may be used. If singular values are computed using qds, DLASQ provided in FORTRAN may be used. These singular value decomposition methods are already known, and thus a detailed description thereof has been omitted. The singular value decomposition portion 15 stores the computed singular values in the singular value decomposition storage portion 16. The singular value decomposition portion 15 also stores matrix elements, which are a part of elements of left and right orthogonal matrices constituted by the computed singular vectors, in the singular value decomposition storage portion 16. The left and right orthogonal matrices constituted by singular vectors refer to a left orthogonal matrix in which each column is represented as a singular vector and a right orthogonal matrix in which each column is represented as a singular vector. The matrix elements will be described later in detail.

In the singular value decomposition storage portion 16, the singular values computed by the singular value decomposition portion 15 performing the singular value decomposition, and the matrix elements described above are stored. Furthermore, in the singular value decomposition storage portion 16, singular values and matrix elements computed by the singular value computing portion 17 are stored. The singular value decomposition storage portion 16 can be realized as a given storage medium (e.g., a semiconductor memory, a magnetic disk, an optical disk, etc.). In the singular value decomposition storage portion 16, data may be temporarily stored in a RAM or the like, or may be stored for a long time.

The singular value computing portion 17 reads out the singular values and the matrix elements computed by the singular value decomposition portion 15, from the singular value decomposition storage portion 16, computes singular values of the bidiagonal matrix from which two bidiagonal matrices have been obtained by the division performed by the matrix dividing portion 14 (hereinafter, referred to as a ‘bidiagonal matrix that is a division origin’) and matrix elements of the bidiagonal matrix that is the division origin based on the singular values and matrix elements, and stores the computed singular values and matrix elements in the singular value decomposition storage portion 16. The singular value computing portion 17 recursively repeats the process of computing singular values and matrix elements of the bidiagonal matrix that is the division origin, until singular values of the bidiagonal matrix B are computed. Then, the singular value computing portion 17 stores the computed singular values of the bidiagonal matrix B in the singular value storage portion 18.

In the singular value storage portion 18, the singular values of the bidiagonal matrix B are stored. The singular value storage portion 18 can be realized as a given storage medium (e.g., a semiconductor memory, a magnetic disk, an optical disk, etc.). In the singular value storage portion 18, data may be temporarily stored in a RAM or the like, or may be stored for a long time.

The singular vector computing portion 19 reads out the bidiagonal matrix B from the diagonal matrix storage portion 13, and reads out the singular values of the bidiagonal matrix B from the singular value storage portion 18. Then, the singular vector computing portion 19 computes singular vectors of the bidiagonal matrix B based on the bidiagonal matrix B and the singular values thereof using twisted factorization, and stores the singular vectors in the singular vector storage portion 20. The singular vector computing portion 19 includes a Cholesky decomposition portion 21, a first singular vector computing portion 22, and a second singular vector computing portion 23 that perform this process. The singular vector computing portion 19 may compute the singular vectors using LV-type twisted factorization, or may compute the singular vectors using qd-type twisted factorization. In this embodiment, the former case will be described.

The Cholesky decomposition portion 21 reads out the bidiagonal matrix B from the diagonal matrix storage portion 13, and reads out the singular values of the bidiagonal matrix B from the singular value storage portion 18. Then, the Cholesky decomposition portion 21 performs Cholesky decomposition on the bidiagonal matrix B into an upper bidiagonal matrix B⁽⁺¹⁾ and a lower bidiagonal matrix B⁽⁻¹⁾, by performing Miura transformation, dLVv-type transformation, and inverse Miura transformation on each element of the bidiagonal matrix B. This process will be described later in detail.

The first singular vector computing portion 22 computes singular vectors constituting one of left and right orthogonal matrices, using each element of the upper bidiagonal matrix B⁽⁺¹⁾ and the lower bidiagonal matrix B⁽⁻¹⁾ computed by the Cholesky decomposition portion 21 and the singular values of the bidiagonal matrix B, and stores the singular vectors in the singular vector storage portion 20.

The second singular vector computing portion 23 reads out the singular values of the bidiagonal matrix B from the singular value storage portion 18. Then, the second singular vector computing portion 23 computes singular vectors constituting the other of the left and right orthogonal matrices, using the singular vectors constituting one of the left and right orthogonal matrices computed by the first singular vector computing portion 22, the singular values of the bidiagonal matrix B, and the bidiagonal matrix B, and stores the computed singular vectors in the singular vector storage portion 20. In this manner, the left and right orthogonal matrices are computed by the first singular vector computing portion 22 and the second singular vector computing portion 23.

In the singular vector storage portion 20, the singular vectors of the bidiagonal matrix B are stored. The singular vector storage portion 20 can be realized as a given storage medium (e.g., a semiconductor memory, a magnetic disk, an optical disk, etc.). In the singular vector storage portion 20, data may be temporarily stored in a RAM or the like, or may be stored for a long time.

Herein, any two or more storage portions of the matrix storage portion 11, the diagonal matrix storage portion 13, the singular value decomposition storage portion 16, the singular value storage portion 18, and the singular vector storage portion 20 may be realized as the same storage medium, or may be realized as different storage media. In the former case, for example, an area in which the matrix A is stored functions as the matrix storage portion 11, and an area in which the bidiagonal matrix B and the like are stored functions as the diagonal matrix storage portion 13.

Furthermore, each storage portion of the matrix storage portion 11, the diagonal matrix storage portion 13, the singular value decomposition storage portion 16, the singular value storage portion 18, and the singular vector storage portion 20 may be constituted by two or more storage media.

Next, the operation of the singular value decomposition apparatus 1 according to this embodiment will be described with reference to the flowchart in FIG. 2.

(step S101) The diagonalization portion 12 reads out the matrix A stored in the matrix storage portion 11, computes the bidiagonal matrix B by bidiagonalizing the matrix A, and stores the bidiagonal matrix B in the diagonal matrix storage portion 13.

(step S102) The singular values of the bidiagonal matrix B are computed by the matrix dividing portion 14, the singular value decomposition portion 15, and the singular value computing portion 17, and stored in the singular value storage portion 18. This process will be described later in detail.

(step S103) The singular vector computing portion 19 reads out the bidiagonal matrix B from the diagonal matrix storage portion 13, reads out the singular values of the bidiagonal matrix B from the singular value storage portion 18, computes the singular vectors of the bidiagonal matrix B, and stores the singular vectors in the singular vector storage portion 20. This process will be described later in detail.

In this manner, the singular value decomposition on the bidiagonal matrix B ends. This means that singular values of the matrix A also have been computed, because the singular values of the matrix A are the same as those of the bidiagonal matrix B. Furthermore, as described later, singular vectors of the matrix A also can be easily computed based on the singular vectors of the bidiagonal matrix B by performing predetermined transformation.

Next, the process in step S102 of the flowchart in FIG. 2 will be described with reference to the flowchart in FIG. 3.

(step S201) The matrix dividing portion 14 reads out the bidiagonal matrix B from the diagonal matrix storage portion 13, divides the bidiagonal matrix B into two bidiagonal matrices, and stores the bidiagonal matrices in the diagonal matrix storage portion 13. The matrix dividing portion 14 repeats the process of dividing the bidiagonal matrix into two bidiagonal matrices until the size of each of the bidiagonal matrices after the division becomes equal to or smaller than a predetermined size.

(step S202) The singular value decomposition portion 15 performs singular value decomposition on each of the bidiagonal matrices whose size is equal to or smaller than the predetermined size stored in the diagonal matrix storage portion 13. The singular value decomposition portion 15 stores singular values obtained by performing the singular value decomposition and matrix elements, which are a part of elements of left and right orthogonal matrices constituted by singular vectors, in the singular value decomposition storage portion 16.

(step S203) The singular value computing portion 17 reads out the singular values and the matrix elements of the bidiagonal matrices from the singular value decomposition storage portion 16, computes singular values of the bidiagonal matrix that is the division origin and matrix elements of the bidiagonal matrix that is the division origin, and stores the singular values and the matrix elements in the singular value decomposition storage portion 16. The singular value computing portion 17 repeats the process of computing singular values and matrix elements of the bidiagonal matrix that is the division origin, until singular values of the bidiagonal matrix B are computed, and stores the singular values of the bidiagonal matrix B in the singular value storage portion 18. In this manner, the process of computing singular values ends.

Next, the process in step S103 of the flowchart in FIG. 2 will be described with reference to the flowchart in FIG. 4.

(step S301) The Cholesky decomposition portion 21 reads out the bidiagonal matrix B from the diagonal matrix storage portion 13, and reads out the singular values of the bidiagonal matrix B from the singular value storage portion 18. Then, the Cholesky decomposition portion 21 performs Cholesky decomposition on the bidiagonal matrix B into an upper bidiagonal matrix B⁽⁺¹⁾ and a lower bidiagonal matrix B⁽⁻¹⁾, by performing Miura transformation, dLVv-type transformation, and inverse Miura transformation on each element of the bidiagonal matrix B.

(step S302) The first singular vector computing portion 22 computes singular vectors constituting one of left and right orthogonal matrices, using each element of the upper bidiagonal matrix B⁽⁺¹⁾ and the lower bidiagonal matrix B⁽⁻¹⁾. In this embodiment, it is assumed that the first singular vector computing portion 22 computes right singular vectors constituting the right orthogonal matrix.

(step S303) The first singular vector computing portion 22 normalizes the computed singular vectors. More specifically, the first singular vector computing portion 22 computes the norm of the computed singular vectors, divides the singular vectors by the computed norm to obtain the final singular vectors, and stores the final singular vectors in the singular vector storage portion 20.

(step S304) The second singular vector computing portion 23 computes singular vectors that are different from the singular vectors computed by the first singular vector computing portion 22, using the singular vectors computed by the first singular vector computing portion 22, the singular values of the bidiagonal matrix B, and the bidiagonal matrix B. As a result of singular value decomposition on the bidiagonal matrix B, the orthogonal matrix constituted by the singular vectors that have been computed by the first singular vector computing portion 22, the orthogonal matrix constituted by the singular vectors that are to be computed by the second singular vector computing portion 23, and the singular values stored in the singular value storage portion 18. Thus, using this aspect, the second singular vector computing portion 23 can compute the singular vectors.

(step S305) The second singular vector computing portion 23 normalizes the computed singular vectors. More specifically, the second singular vector computing portion 23 computes the norm of the computed singular vectors, divides the singular vectors by the computed norm to obtain the final singular vectors, and stores the final singular vectors in the singular vector storage portion 20. In this manner, the singular value decomposition on the bidiagonal matrix B ends.

Subsequently, the process of computing the singular vectors of the matrix A stored in the matrix storage portion 11 may be performed, but has been omitted in this example.

Furthermore, in order to improve the accuracy of the singular vectors computed by the singular vector computing portion 19, a process relating to the singular vectors may be performed as shown in FIG. 5, or may not be performed. More specifically, an inverse iteration processing portion (not shown) reads out the singular vectors computed by the singular vector computing portion 19 from the singular vector storage portion 20, processes the singular vectors using inverse iteration, and stores the resultant singular vectors in the singular vector storage portion 20 (step S401). Next, a Gram-Schmidt processing portion (not shown) judges whether or not high accuracy is necessary (step S402). This judgment may be performed by reading out the setting regarding whether or not high accuracy is necessary, from a storage medium or the like in which the setting is stored in advance. If high accuracy is necessary, the Gram-Schmidt processing portion (not shown) reads out the singular vectors processed using inverse iteration from the singular vector storage portion 20, processes the singular vectors using Gram-Schmidt method, and stores the resultant singular vectors in the singular vector storage portion 20 (step S403). Herein, the inverse iteration and the Gram-Schmidt method are already known, and thus a detailed description thereof has been omitted.

Next, the operation of the singular value decomposition apparatus 1 according to this embodiment will be described below in more detail.

### [Diagonalization of the Matrix A]

It is known that the matrix A can be bidiagonalized as shown below, for example, using Householder transformation or the like. Herein, a case will be described in which the matrix A is transformed into an upper bidiagonal matrix. However, the matrix A can be transformed also into a lower bidiagonal matrix in a similar manner. The bidiagonal matrix B is a square matrix in which the number of rows is equal to that of columns.

$${U}_{H}^{T} {AV}_{H} = \{ \begin{matrix}( B 0 ) & ( {l}_{1} \leq {l}_{2} ) \\ ( \begin{matrix}B \\ 0\end{matrix} ) & ( {l}_{1} \geq {l}_{2} ) ,\end{matrix} \\ B = ( \begin{matrix}{b}_{1} & {b}_{2} & & \\ & {b}_{3} & ⋱ & \\ & & ⋱ & {b}_{2 m - 2} \\ 0 & & & {b}_{2 m - 1}\end{matrix} )$$

where, A is an l₁×l₂ real matrix, U_{H} and V_{H} are orthogonal matrices, and m=min(l₁, l₂).

Accordingly, the diagonalization portion 12 can read out the matrix A from the matrix storage portion 11, and compute the bidiagonal matrix B, as described above. The computed bidiagonal matrix is stored in the diagonal matrix storage portion 13 (step S101).

[Division of the Bidiagonal Matrix B]

Next, the process of dividing the bidiagonal matrix B will be described. First, as shown in FIG. 6, a column with all elements 0 is added to the right of the matrix B that is an upper bidiagonal matrix and is a square matrix, and the resultant matrix is newly taken as an upper bidiagonal matrix B. It should be noted that singular values of the new bidiagonal matrix B are the same as those of the bidiagonal matrix B that is the previous square matrix. Hereinafter, the process of obtaining singular values of the new n×(n+1) matrix will be described.

As shown in FIG. 7, in a case where an n×(n+1) upper bidiagonal matrix B is given, the upper bidiagonal matrix B can be divided into two upper bidiagonal matrices and two elements (b₇ and b₈ in FIG. 7). Accordingly, the upper bidiagonal matrix B is divided as follows.

$$B = ( \begin{matrix}{B}_{1} & 0 \\ {b}_{2 k - 1} {e}_{k}^{T} & {b}_{2 k} {e}_{1}^{T} \\ 0 & {B}_{2}\end{matrix} ) \qquad Equation 1$$

Herein, the upper bidiagonal matrix B is an n×(n+1) matrix. Thus, the upper bidiagonal matrix B₁ is a (k−1)×k matrix, and the upper bidiagonal matrix B₂ is an (n−k)×(n−k+1) matrix. Furthermore, k is an integer in the range of 1<k<n, and eⱼ is the j^{th} unit vector of appropriate dimensions. In order to perform parallel processing as appropriate, k is preferably the largest integer not greater than n/2 or the smallest integer not less than n/2 (the process of dividing a matrix into two matrices using k is referred to as a process of ‘dividing a matrix into two substantially half matrices’).

k=└n/2┘

In this embodiment, k is taken as shown in this equation. It will be appreciated that k may be any value in the range of 1<k<n as described above.

Accordingly, the matrix dividing portion 14 can divide the upper bidiagonal matrix B stored in the diagonal matrix storage portion 13 into two upper bidiagonal matrices and two elements as described above, and repeat the division process. FIG. 8 is a flowchart showing the process in which the matrix dividing portion 14 divides a matrix in step S201 of the flowchart in FIG. 3.

(step S501) The matrix dividing portion 14 sets a counter I to ‘1’.

(step S502) The matrix dividing portion 14 reads out a bidiagonal matrix that has not been subjected to the I^{th} division from the diagonal matrix storage portion 13, and divides the bidiagonal matrix into two bidiagonal matrices and two elements. Then, the matrix dividing portion 14 stores the two bidiagonal matrices and the two elements obtained by the division in the diagonal matrix storage portion 13.

(step S503) The matrix dividing portion 14 judges whether or not a bidiagonal matrix that has not been subjected to the I^{th} division is stored in the diagonal matrix storage portion 13. If a bidiagonal matrix that has not been subjected to the I^{th} division is stored in the diagonal matrix storage portion 13, the procedure returns to step S502. If not, the procedure proceeds to step S504.

(step S504) The matrix dividing portion 14 judges whether or not the size of the bidiagonal matrices after the I^{th} division is equal to or smaller than a predetermined size. For example, the matrix dividing portion 14 may read out a target matrix size (e.g., 25×26, etc.) from a storage medium (not shown) in which the target matrix size is stored, and judge whether or not the size of the bidiagonal matrices after the I^{th} division stored in the diagonal matrix storage portion 13 is equal to or smaller than this size. If the size of the bidiagonal matrices after the I^{th} division is equal to or smaller than the predetermined size, the process of dividing bidiagonal matrix ends. If not, the procedure proceeds to step S505.

(step S505) The matrix dividing portion 14 increments the counter I by 1. Then, the procedure returns to step S502.

Herein, in the flowchart in FIG. 8, a case was described in which the matrix dividing portion 14 divides each matrix into two substantially half matrices as described above, and thus the bidiagonal matrices after the I^{th} division have substantially the same size. However, in a case where the matrix dividing portion 14 does not divide each matrix into two substantially half matrices, the matrix dividing portion 14 is to repeat division such that each of matrices after the division is equal to or smaller than the predetermined size.

Furthermore, in the flowchart in FIG. 8, a case was described in which in step S504, the matrix dividing portion 14 performs the process of comparing the size of matrices after the division stored in the diagonal matrix storage portion 13 with a predetermined size, but this is merely an example. The matrix dividing portion 14 may perform other processes in step S504. For example, in a case where the matrix dividing portion 14 divides each matrix into two substantially half matrices as described above, if the size of the original bidiagonal matrix B can be known, then it can be known which division provides the target matrix size. Accordingly, in a case where the N^{th} division (N is an integer of 1 or more) provides the target matrix size, the following algorithm may be used in which it is judged in step S504 whether or not I is N, and the procedure proceeds to step S505 if I is not N, or the series of processes end if I is N.

FIG. 9 is a diagram for illustrating division of a matrix. First, the matrix dividing portion 14 divides the bidiagonal matrix B into a bidiagonal matrix B₁ and a bidiagonal matrix B₂ as the first division (steps S501 and S502). Since there is only one bidiagonal matrix B, the matrix dividing portion 14 judges that there is no more matrix that has not been subjected to the first division (step S503). Furthermore, if the bidiagonal matrix B₁ and the like are not matrices whose size is equal to or smaller than the predetermined size (step S504), the matrix dividing portion 14 divides the bidiagonal matrix B₁ into a bidiagonal matrix B₁₁ and a bidiagonal matrix B₁₂ as the second division (steps S505 and S502). In this case, since there is the bidiagonal matrix B₂ that has not been subjected to the second division, the matrix dividing portion 14 also divides the bidiagonal matrix B₂ into a bidiagonal matrix B₂₁ and a bidiagonal matrix B₂₂ (steps S503 and S502). In this manner, the process of dividing the matrix is repeated until each of the bidiagonal matrices after the division becomes equal to or smaller than a target size. In FIG. 9, two elements that are not included in the bidiagonal matrices are omitted. Furthermore, in FIG. 9, each of the bidiagonal matrices is a matrix having one more columns than rows.

[Singular Value Decomposition of Matrices After Division]

If it is assumed that a matrix Bᵢ is an n×(n+1) matrix, singular value decomposition of the matrix Bᵢ is as follows.

Bᵢ=Uᵢ(Dᵢ0)(Vᵢvᵢ)^{T}

In the equation, Dᵢ is an n×n diagonal matrix, and (Dᵢ0) is a matrix in which one column with all elements 0 is on the right side of the matrix Dᵢ. Each of the diagonal elements in the matrix Dᵢ is a singular value of the matrix Bᵢ. Furthermore, vᵢ is a vector at the right end of the right orthogonal matrix in the singular value decomposition of the matrix Bᵢ, and Vᵢ is vectors other than the vector vᵢ of the right orthogonal matrix in the singular value decomposition of the matrix Bᵢ. Furthermore, (Vᵢvⱼ)^{T} as a whole is an (n+1)×(n+1) matrix.

Accordingly, the singular value decomposition portion 15 reads out each of the upper bidiagonal matrices after the division from the diagonal matrix storage portion 13, and performs singular value decomposition as described above (step S202). For example, as described above, it is possible to use bisection and inverse iteration in combination, MR̂3, QRs, or the like, as a singular value decomposition method. In a case where upper bidiagonal matrices are divided as shown in FIG. 9, the singular value decomposition portion 15 performs singular value decomposition on each of the bidiagonal matrices B₁₁₁, B₁₁₂, B₁₂₁, B₁₂₂, . . . , and B₂₂₂. Herein, the singular value decomposition portion 15 stores singular values obtained by performing the singular value decomposition and matrix elements, which are a part of elements of left and right orthogonal matrices obtained by performing the singular value decomposition, in the singular value decomposition storage portion 16. Herein, which element in the left and right orthogonal matrices is contained in a matrix element will be described later.

### [Computation of Singular Values]

First, the process of computing singular values and the like of a bidiagonal matrix B₀ that is a division origin based on two bidiagonal matrices B₁ and B₂ after the division as shown in FIG. 10 will be described. It is assumed that singular value decomposition was performed on the bidiagonal matrices B₁ and B₂ as follows. Herein, it is assumed that both of the bidiagonal matrices B₁ and B₂ are matrices having one more columns than rows.

B₁=U₁(D₁0)(V₁v₁)^{T}

B₂=U₂(D₂0)(V₂v₂)^{T}

In this case, the bidiagonal matrix B₀ that is the division origin becomes as follows.

$${B}_{0} = ( \begin{matrix}0 & {U}_{1} & 0 \\ 1 & 0 & 0 \\ 0 & 0 & {U}_{2}\end{matrix} ) ( \begin{matrix}{b}_{2 k - 1} {Ψ}_{1} & {b}_{2 k - 1} {I}_{1} & {b}_{2 k} {f}_{2} & {b}_{2 k} {φ}_{2} \\ 0 & {D}_{1} & 0 & 0 \\ 0 & 0 & {D}_{2} & 0\end{matrix} ) \times {( \begin{matrix}{v}_{1} & {V}_{1} & 0 & 0 \\ 0 & 0 & {V}_{2} & {v}_{2}\end{matrix} )}^{T}$$

where l₁ is the last row in V₁, ψ₁ is the last element of v₁, f₂ is the first row of V₂, and φ₂ is the first element of v₂.

Furthermore, b₂ₖ₋₁ and the like in this equation are matrix elements described in the process of dividing a bidiagonal matrix. The following equation is obtained by Givens transformation to make b_{2kφ2} zero.

B₀=Ũ(M0)(\tilde{V}\tilde{v})^{T}

In the equation,

$$\tilde{U} ≡ ( \begin{matrix}0 & {U}_{1} & 0 \\ 1 & 0 & 0 \\ 0 & 0 & {U}_{2}\end{matrix} ) , \\ M ≡ ( \begin{matrix}{r}_{0} & {b}_{2 k - 1} {I}_{1} & {b}_{2 k} {f}_{2} \\ 0 & {D}_{1} & 0 \\ 0 & 0 & {D}_{2}\end{matrix} )$$

$$\tilde{V} ≡ ( \begin{matrix}{c}_{0} {v}_{1} & {V}_{1} & 0 \\ {s}_{0} {v}_{2} & 0 & {V}_{2}\end{matrix} ) , \\ \tilde{v} ≡ ( \begin{matrix}- {s}_{0} {v}_{1} \\ {c}_{0} {v}_{2}\end{matrix} )$$

$${r}_{0} = \sqrt{{( {b}_{2 k - 1} {Ψ}_{1} )}^{2} + {( {b}_{2 k} {φ}_{2} )}^{2} ,}$$

$${c}_{0} = \frac{{b}_{2 k - 1} {Ψ}_{1}}{{r}_{0}} , \\ {s}_{0} = \frac{{b}_{2 k} {φ}_{2}}{{r}_{0}} .$$

Accordingly, the matrix B₀ is transformed into (M0) by orthogonal transformation with Ũ, (\tilde{V}\tilde{v})^{T}. Thus, in order to perform singular value decomposition on the matrix B₀, singular value decomposition on the matrix M may be performed. Herein, the n×n matrix M is taken as follows.

$$M = ( \begin{matrix}{z}_{1} & {z}_{2} & … & {z}_{n} \\ & {d}_{2} & & \\ & & ⋱ & \\ & & & {d}_{n}\end{matrix} )$$

In this matrix M, all elements other than zᵢ or dⱼ are 0. Furthermore, i=1, 2, . . . , n, and j=2, 3, . . . , n. It is possible to perform this singular value decomposition on the matrix M based on the following theorems.

Theorem 1

If the singular value decomposition of M is taken as UΣV^{T}, and U=(u₁, . . . , uₙ), Σ=diag(σ₁, . . . σₙ), V=(v₁, . . . , vₙ), then the singular values {σᵢ}ᵢ₌₁ⁿ satisfy 0=d₁<σ₁<d₂< . . . <dₙ<σₙ<dₙ+∥z∥₂. Herein, a singular value equation is given as follows.

$$f ( {σ}_{i} ) ≡ 1 + {\sum }_{j = 1}^{n} \frac{{z}_{j}^{2}}{{d}_{j}^{2} - {σ}_{i}^{2}} = 0 \qquad Equation 2$$

Singular vectors are obtained as follows.

$$\begin{matrix}{u}_{i} = \frac{{( - 1 , \frac{{d}_{2} {z}_{2}}{{d}_{2}^{2} - {σ}_{i}^{2}} , … , \frac{{d}_{n} {z}_{n}}{{d}_{n}^{2} - {σ}_{i}^{2}} )}^{T}}{\sqrt{1 + {\sum }_{k = 2}^{n} \frac{{( {d}_{k} {z}_{k} )}^{2}}{{( {d}_{k}^{2} - {σ}_{i}^{2} )}^{2}}}} & Equation 3 \\ {v}_{i} = \frac{{( \frac{{z}_{1}}{{d}_{1}^{2} - {σ}_{i}^{2}} , … , \frac{{z}_{n}}{{d}_{n}^{2} - {σ}_{i}^{2}} )}^{T}}{\sqrt{{\sum }_{k = 1}^{n} \frac{{z}_{k}^{2}}{{( {d}_{k}^{2} - {σ}_{i}^{2} )}^{2}}}} & Equation 4\end{matrix}$$

Herein, values that can be obtained using a calculating machine are not exact singular values of the matrix M but approximations thereof including an error. Accordingly,

$$\frac{{z}_{k}}{{d}_{k}^{2} - {\hat{σ}}_{i}^{2}} , \frac{{d}_{k} {z}_{k}}{{d}_{k}^{2} - {\hat{σ}}_{i}^{2}}$$

(where \hat{σ}ᵢ is an approximation obtained using a calculating machine) may be significantly different from

$$\frac{{z}_{k}}{{d}_{k}^{2} - {σ}_{i}^{2}} , \frac{{d}_{k} {z}_{k}}{{d}_{k}^{2} - {\hat{σ}}_{i}^{2}} ,$$

which are exact values. More specifically, in a case where calculation is performed as described above, calculation of singular vectors may be numerically unstable. This problem can be solved with the following theorem.

Theorem 2

If a diagonal matrix D=diag(d₁, . . . , dₙ) is given, and a set {\hat{σ}ᵢ}ᵢ₌₁ⁿ satisfying 0≡d₁<\hat{σ}₁<d₂< . . . <dₙ<\hat{σ}ₙ is given, then a matrix

$$\hat{M} = ( \begin{matrix}{\hat{z}}_{1} & {\hat{z}}_{2} & … & {\hat{z}}_{n} \\ & {d}_{2} & & \\ & & ⋱ & \\ & & & {d}_{n}\end{matrix} )$$

whose singular values are represented as {\hat{σ}ᵢ}ᵢ₌₁ⁿ is present. The vector \hat{z}=(\hat{z}₁, \hat{z}₂, . . . , \hat{z}ₙ)^{T} is given as the following equation.

$$\vert {\hat{z}}_{i} \vert = \sqrt{( {\hat{σ}}_{n}^{2} - {d}_{i}^{2} ) {\prod }_{k = 1}^{i - 1} \frac{( {\hat{σ}}_{k}^{2} - {d}_{i}^{2} )}{( {d}_{k}^{2} - {d}_{i}^{2} )} {\prod }_{k = i}^{n - 1} \frac{( {\hat{σ}}_{k}^{2} - {d}_{i}^{2} )}{( {d}_{k + 1}^{2} - {d}_{i}^{2} )}} \qquad Equation 5$$

where the sign of \hat{z}ᵢ may be arbitrarily selected.

Accordingly, after approximate singular values of the matrix M are computed using Theorem 1, the matrix M taking approximate singular values as exact singular values is rebuilt using Theorem 2. It is possible to obtain the singular vectors in a numerically stable manner, by substituting \hat{z}ᵢ computed using Equation 5 and \hat{σ}ᵢ computed using Equation 2 for Equations 3 and 4. In this manner, the singular value decomposition of the matrix M is obtained as follows.

M=U_{M}ΣV_{M}^{T}

where U_{M}=(û₁, . . . , ûₙ), Σ=diag(\hat{σ}₁, . . . , \hat{σ}ₙ), V_{M}=(\hat{v}₁, . . . , \hat{v}ₙ), and ûᵢ and \hat{v}ᵢ are uᵢ, vᵢ computed respectively using \hat{z}ᵢ and \hat{σ}ᵢ.

Then, the singular value decomposition of B₀ is as follows.

$$\begin{matrix}{B}_{0} = \tilde{U} ( M 0 ) {( \tilde{V} \tilde{v} )}^{T} \\ = \tilde{U} ( {U}_{M} Σ {V}_{M}^{T} 0 ) {( \tilde{V} \tilde{v} )}^{T} \\ = \tilde{U} {U}_{M} ( Σ 0 ) {( \begin{matrix}{V}_{M} & 0 \\ 0 & 1\end{matrix} )}^{T} {( \tilde{V} \tilde{v} )}^{T} \\ = U ( Σ 0 ) {( \tilde{V} {V}_{M} \tilde{v} )}^{T} \\ = U ( Σ 0 ) {V}^{T}\end{matrix}$$

The method for performing singular value decomposition by recursively performing the process in which a target matrix is divided into two submatrices and singular value decomposition is performed on each of the submatrices after the division is referred to as Divide and Conquer (D&C).

In D&C, singular vectors are also computed. In the process of computing the singular vectors, matrix calculation has to be performed. Thus, D&C requires very heavy load in the process. In a case where singular value decomposition is performed by D&C, for example, approximately 95% of calculation time may be used for the vector update process in which singular vectors are computed (e.g., matrices are multiplied in order to compute left and right orthogonal matrices of the matrix B₀ based on the left and right orthogonal matrices of the matrix M as described above).

On the other hand, in a case where only singular values are to be computed, this process can be simplified. Next, this method will be described. Based on the above-mentioned result, the following equation is obtained.

$$\begin{matrix}{B}_{0} = \tilde{U} ( M 0 ) {( \tilde{V} \tilde{v} )}^{T} \\ = U ( Σ 0 ) {( \tilde{V} {V}_{M} \tilde{v} )}^{T} \\ = U ( Σ 0 ) {( ( \begin{matrix}{c}_{0} {v}_{1} & {V}_{1} & 0 \\ {s}_{0} {v}_{2} & 0 & {V}_{2}\end{matrix} ) {V}_{M} ( \begin{matrix}- {s}_{0} {v}_{1} \\ {c}_{0} {v}_{2}\end{matrix} ) )}^{T}\end{matrix}$$

Thus, the following equations are obtained.

f=(c₀φ₁f₁0)V_{M} Equation 6

l=(s₀ψ₂0l₂)V_{M} Equation 7

φ=−s₀φ₁ Equation 8

ψ=c₀ψ₂ Equation 9

where f₁ is the first row of V₁, +₁ is the first element of v₁, l₂ is the last row of V₂, l is the last row of V, ψ is the last element of v, f is the first row of V, and φ is the first element of v. Herein, f and φ are elements of the first row of the right orthogonal matrix obtained by performing singular value decomposition on the matrix B₀. Furthermore, l and ψ are elements of the last row of the right orthogonal matrix obtained by performing singular value decomposition on the matrix B₀. The elements of the first row and the elements of the last row of the right orthogonal matrix function as matrix elements.

Based on the above-mentioned result, in a case where the matrix B₀ that is a division origin is built based on the matrices B₁ and B₂ as shown in FIG. 10, \hat{σ}ᵢ, \hat{z}ᵢ, V_{M}, f, l, φ, ψ can be computed for the matrix B₀. It is possible to finally compute singular values of the bidiagonal matrix B in which the matrix A is bidiagonalized, by repeating this process.

As described above, the singular value computing portion 17 reads out the singular values and the matrix elements from the singular value decomposition storage portion 16, reads out the two elements (b₂ₖ₋₁, b₂ₖ) generated at the time of the matrix division from the diagonal matrix storage portion 13, and computes singular values and matrix elements of the bidiagonal matrix that is the division origin using the read values. Then, singular values of the bidiagonal matrix B are finally computed by repeating this computation process. FIG. 11 is a flowchart showing the process in which the singular value computing portion 17 computes singular values in step S203 of the flowchart in FIG. 3.

(step S601) The singular value computing portion 17 sets a counter J to ‘1’.

(step S602) The singular value computing portion 17 judges whether or not the J^{th} computation of singular values is the last computation of singular values. Herein, the last computation of singular values refers to a process of computing singular values of the bidiagonal matrix B. If the J^{th} computation of singular values is the last computation of singular values, the procedure proceeds to step S606. If not, the procedure proceeds to step S603.

(step S603) The singular value computing portion 17 computes singular values and the like of the bidiagonal matrix that is the division origin. This process will be described later in detail.

(step S604) The singular value computing portion 17 judges whether or not singular values and the like of all bidiagonal matrices that are the division origins have been computed in the J^{th} computation of singular values. If singular values and the like of all bidiagonal matrices that are the division origins have been computed in the J^{th} computation of singular values, the procedure proceeds to step S605. If not, the procedure returns to step S603.

(step S605) The singular value computing portion 17 increments the counter J by 1. Then, the procedure returns to step S602.

(step S606) The singular value computing portion 17 computes singular values of the bidiagonal matrix B, and stores the computed singular values in the singular value storage portion 18. In this manner, the series of processes of computing singular values of the bidiagonal matrix B end.

FIG. 12 is a flowchart showing a detailed process in step S603 of the flowchart in FIG. 11.

(step S701) The singular value computing portion 17 computes singular values of the matrix that is the division origin using Equation 2. Then, the singular value computing portion 17 stores the computed singular values in the singular value decomposition storage portion 16.

(step S702) The singular value computing portion 17 computes z of Equation 5, using the singular values computed in step S701.

(step S703) The singular value computing portion 17 computes vᵢ of Equation 4, using the singular values computed in step S701 and z computed in step S702. Computation of vᵢ means computation of V_{M} whose column vector is represented as vᵢ. Then, the singular value computing portion 17 stores the computed V_{M} in the singular value decomposition storage portion 16.

(step S704) The singular value computing portion 17 computes matrix elements relating to the matrix that is the division origin using Equations 6 to 9. Then, the singular value computing portion 17 stores the computed matrix elements relating to the matrix that is the division origin in the singular value decomposition storage portion 16. In this manner, the process in step S603 ends.

FIG. 13 is a diagram for illustrating the process of computing singular values. It is assumed that as a result of singular value decomposition performed by the singular value decomposition portion 15 on the matrices B₁₁₁, B₁₁₂, . . . , and B₂₂₂, the singular values and the matrix elements of the matrices are stored in the singular value decomposition storage portion 16. First, the singular value computing portion 17 starts the first computation of singular values and the like (steps S601 and S602). Herein, the first computation of singular values and the like refers to a process of computing singular values and matrix elements of the second matrices from the bottom based on the singular values and the matrix elements of the matrices at the bottom in FIG. 13. The singular value computing portion 17 reads out the singular values of the matrices B₁₁₁ and B₁₁₂ and the matrix elements of the matrices B₁₁₁ and B₁₁₂, from the singular value decomposition storage portion 16. Also, the singular value computing portion 17 reads out two elements generated at the time of decomposition of the matrix B₁₁ into the matrices B₁₁₁ and B₁₁₂, from the diagonal matrix storage portion 13. Then, the singular value computing portion 17 computes singular values of the matrix B₁₁ using these values, and stores the singular values in the singular value decomposition storage portion 16 (step S701). Next, the singular value computing portion 17 computes z using the singular values of the matrix B₁₁ (step S702). The singular value computing portion 17 computes an orthogonal matrix V_{M} using the singular values of matrix B₁₁ and z, and stores the orthogonal matrix V_{M} in the singular value decomposition storage portion 16 (step S703). Lastly, the singular value computing portion 17 computes the matrix elements of the matrix B₁₁, and stores the matrix elements in the singular value decomposition storage portion 16 (step S704).

Since the first computation of singular values and the like has not ended yet (step S604), the singular value computing portion 17 computes singular values and matrix elements of the matrix B₁₂ based on the singular values, the matrix elements, and the like of the matrices B₁₂₁ and B₁₂₂ as described above (steps S602 and S603). In this manner, the first computation of singular values and the like ends. Then, the singular value computing portion 17 performs the second computation of singular values and the like, that is, computation of singular values and matrix elements of the matrix B₁ based on the singular values, the matrix elements, and the like of the matrices B₁₁ and B₁₂ (steps S604, S605, S602 and S603). Subsequently, the singular value computing portion 17 computes singular values and matrix elements of the matrix B₂ based on the singular values, the matrix elements, and the like of the matrices B₂₁ and B₂₂ in a similar manner (steps S604 and S603).

If the singular value computing portion 17 ends the second computation of singular values and the like (step S604), since the next computation of singular values and the like is the last process in which the singular values of the bidiagonal matrix B are obtained (steps S605 and S602), the singular value computing portion 17 computes only the singular values, and stores the computed singular values in the singular value storage portion 18 (step S606). In this manner, the computation of singular values ends.

[Computation of Singular Vectors Based on Singular Values]

First, the matrix B^{T}B is considered. Herein, the matrix B is the above-described n×n upper bidiagonal matrix. It is assumed that this matrix B^{T}B is diagonalized as follows.

Λ=V^{T}B^{T}BV
Λ≡diag(λ₁,λ₂, . . . , λₘ), (λ₁≧λ₂≧ . . . ≧λₘ≧0)
where V≡(x₁, x₂, . . . , xₘ)
   λⱼ is an eigenvalue of B^{T}B, and xⱼ is an eigenvector with respect to the eigenvalue λⱼ.

Herein, generally,

(1) the matrix B^{T}B is a symmetric tridiagonal matrix,

(2) all eigenvalues of the matrix B^{T}B are positive, and the singular value σⱼ (σ₁≧σ₂≧ . . . ≧σₘ≧0) of the matrix B has the following relationship with the eigenvalue of the matrix B^{T}B:

$${σ}_{j} = \sqrt{{λ}_{j}} ,$$

and

(3) V_{B}=V, where V_{B} is the right orthogonal matrix of the matrix B, and thus the eigenvector xⱼ of the matrix B^{T}B is equal to the right singular vector of the matrix B.

Accordingly, if the eigenvector of the matrix B^{T}B has been obtained, the right orthogonal matrix of the matrix B also has been obtained. Moreover, the eigenvalue decomposition of the matrix B is taken as follows.

U_{B}ΣV_{B}^{T}=B

Then, the right orthogonal matrix V_{B} is obtained, and a matrix Σ whose diagonal elements are represented as the singular values is also obtained. Thus, the left orthogonal matrix is also obtained using U_{B}=BV_{B}Σ⁻¹, and singular value decomposition is performed on the matrix B. Accordingly, computation of the singular vector of the matrix B can be replaced by computation of the eigenvector of matrix B^{T}B=T_{S}. That is to say, only the eigenvector xⱼ in the following equation has to be obtained.

(B^{T}B−σⱼ²I)xⱼ=γₖeₖ (j=1, 2, . . . , m)

where the matrix B is an m×m matrix, and eₖ is a vector in which the k^{th} element is 1 and the other elements are 0 (eₖ is the k^{th} row of the unit matrix I).

It is natural that the right side of this equation should be 0. However, some errors are included in computation of the singular values of the matrix B, and thus there is a residual in the right side as shown above if the singular vector xⱼ is a true value.

It is herein assumed that Cholesky decomposition has been performed as follows.

$${B}^{T} B - {σ}_{j}^{2} I = \{ \begin{matrix}{( {B}^{( + 1 )} )}^{T} {B}^{( + 1 )} \\ {( {B}^{( - 1 )} )}^{T} {B}^{( - 1 )}\end{matrix} \\ {B}^{( n )} ≡ ( \begin{matrix}{b}_{1}^{( n )} & {b}_{2}^{( n )} & & \\ & {b}_{3}^{( n )} & ⋱ & \\ & & ⋱ & {b}_{2 m - 2}^{( n )} \\ 0 & & & {b}_{2 m - 1}^{( n )}\end{matrix} ) , \\ ( n = 0 , + 1 ) , \\ {B}^{( 0 )} ≡ B \\ {B}^{( - 1 )} ≡ ( \begin{matrix}{b}_{1}^{( - 1 )} & & & 0 \\ {b}_{2}^{( - 1 )} & {b}_{3}^{( - 1 )} & & \\ & ⋱ & ⋱ & \\ & & {b}_{2 m - 2}^{( - 1 )} & {b}_{2 m - 1}^{( - 1 )}\end{matrix} ) \\ {b}_{2 k - 1}^{( n )} ≡ {ξ}_{k}^{( n )} \sqrt{{q}_{k}^{( n )}} , \\ {b}_{2 k}^{( n )} ≡ {η}_{k}^{( n )} \sqrt{{e}_{k}^{( n )}} , \\ {( {ξ}_{k}^{( n )} )}^{2} = 1 , \\ {( {η}_{k}^{( n )} )}^{2} = 1 , \\ ( n = 0 , + 1 , - 1 ) , \\ {ξ}_{k}^{( 1 )} {η}_{k}^{( 1 )} = {ξ}_{k}^{( 0 )} {η}_{k}^{( 0 )} , \\ {ξ}_{k + 1}^{( - 1 )} {η}_{k}^{( - 1 )} = {ξ}_{k}^{( 0 )} {η}_{k}^{( 0 )}$$

Thus,

$${B}^{T} B - {σ}_{j}^{2} I = \{ \begin{matrix}{LD}^{+} {L}^{T} \\ {UD}^{-} {U}^{T} ,\end{matrix}$$

where L, U, and D are as follows.

$$L ≡ ( \begin{matrix}1 & & & 0 \\ {L}_{1} & 1 & & \\ & ⋱ & ⋱ & \\ & & {L}_{m - 1} & 1\end{matrix} ) , \\ {L}_{k} ≡ \frac{{b}_{2 k}^{( + 1 )}}{{b}_{2 k - 1}^{( + 1 )}}$$

$$U ≡ ( \begin{matrix}1 & {U}_{1} & & \\ & 1 & ⋱ & \\ & & ⋱ & {U}_{m - 1} \\ 0 & & & 1\end{matrix} ) , \\ {U}_{k} ≡ \frac{{b}_{2 k}^{( - 1 )}}{{b}_{2 k + 1}^{( - 1 )}}$$

$${D}^{\pm } ≡ diag ( {D}_{1}^{\pm } , {D}_{2}^{\pm } , … , {D}_{m}^{\pm } ) , \\ {D}_{k}^{\pm } ≡ {( {b}_{2 k - 1}^{( \pm 1 )} )}^{2}$$

Then, the following equations are obtained.

$${B}^{T} B - {σ}_{j}^{2} I = {N}_{k} {{D}_{k} ( {N}_{k} )}^{T}$$

$${N}_{k} ≡ ( \begin{matrix}1 & & & & & & \\ {L}_{1} & 1 & & & & & \\ & ⋱ & ⋱ & & & & \\ & & {L}_{k - 1} & 1 & {U}_{k} & & \\ & & & & 1 & ⋱ & \\ & & & & & ⋱ & {U}_{m} \\ & & & & & & 1\end{matrix} ) , \\ {D}_{k} ≡ diag ( {D}_{1}^{+} , {D}_{2}^{+} , … , {D}_{k - 1}^{+} , {γ}_{k} , {D}_{k + 1}^{-} , … , {D}_{m}^{-} )$$

Herein, the matrix Nₖ is referred to as a twisted matrix. Furthermore, Dₖeₖ=γₖeₖ, Nₖeₖ=eₖ. Thus, (B^{T}B−σⱼ²I)xⱼ=γₖeₖ is Nₖ^{T}xⱼ=eₖ. It is possible to compute singular vectors by solving this simple equation. More specifically, it is possible to compute singular vectors with a small amount of operation such as:

$${x}_{j} ( ρ ) = \{ \begin{matrix}1 , & ρ = k , \\ - {L}_{ρ} {x}_{j} ( ρ + 1 ) , & ρ = k - 1 , k - 2 , … , 1 , \\ - {U}_{ρ - 1} {x}_{j} ( ρ - 1 ) , & ρ = k + 1 , k + 2 , … , m ,\end{matrix}$$

where xⱼ(ρ) is the ρ^{th} element of xⱼ. Herein, even if D_{ρ0}⁺=0 or D_{ρ0}⁻=0 with respect to a given ρ0, it is possible to compute singular vectors using b_{2ρ-1}⁽⁰⁾, which is the (ρ, ρ) element of the matrix B, and b_{2ρ}⁽⁰⁾, which is the (ρ, ρ+1) element of the matrix B, as follows (the process of computing singular vectors in this manner is referred to as an exceptional process).

$${x}_{j} ( ρ 0 ) = \{ \begin{matrix}- \frac{{b}_{2 ρ 0 + 1}^{( 0 )} {b}_{2 ρ 0 + 2}^{( 0 )}}{{b}_{2 ρ 0 - 1}^{( 0 )} {b}_{2 ρ 0}^{( 0 )}} {x}_{j} ( ρ 0 + 2 ) , & ρ 0 < k , \\ - \frac{{b}_{2 ρ 0 - 5}^{( 0 )} {b}_{2 ρ 0 - 4}^{( 0 )}}{{b}_{2 ρ 0 - 3}^{( 0 )} {b}_{2 ρ 0 - 2}^{( 0 )}} {x}_{j} ( ρ 0 - 2 ) , & ρ 0 > k\end{matrix}$$

Herein, the parameter γₖ and the value k of the residual are determined such that the absolute value of the following equation becomes smallest.

γₖ≡qₖ⁽⁺¹⁾⁺qₖ⁽⁻¹⁾−(eₖ₋₁⁽⁰⁾+qₖ⁽⁰⁾−σⱼ²) Equation 10

Accordingly, if the above-described Cholesky decomposition is obtained, and the twisted matrix Nₖ is obtained, then singular vectors can be obtained. Next, Cholesky decomposition will be described.

As shown in FIG. 14, Cholesky decomposition of B^{(0)T}B⁽⁰⁾−σⱼ²I is the same as computation of {qₖ^{(±1)}, eₖ^{(±1)}} corresponding to B^{(±1)} based on {qₖ⁽⁰⁾, eₖ⁽⁰⁾} corresponding to B⁽⁰⁾.

(qd-Type Twisted Factorization)

First, qd-type transformation used in conventionally known qd-type twisted factorization will be described (see FIG. 14).

qd-type transformation: {qₖ⁽⁰⁾,eₖ⁽⁰⁾} [symbol] {qₖ^{(±1)},eₖ^{(±1)}}

This transformation is further divided into stationary qd with shift (stqds) transformation: {qₖ⁽⁰⁾,eₖ⁽⁰⁾} [symbol] {qₖ⁽⁺¹⁾,eₖ⁽⁺¹⁾} qₖ⁽⁺¹⁾+eₖ₋₁⁽⁺¹⁾=qₖ⁽⁰⁾+eₖ₋₁⁽⁰⁾−σⱼ², k=1, 2, . . . , m, qₖ⁽⁺¹⁾eₖ⁽⁺¹⁾=qₖ⁽⁰⁾eₖ⁽⁰⁾, k=1, 2, . . . , m−1, e₀⁽⁰⁾≡0, e₀⁽⁺¹⁾≡0, and reverse-time progressive qd with shift (rpqds) transformation: {qₖ⁽⁰⁾,eₖ⁽⁰⁾} [symbol] {qₖ⁽⁻¹⁾,eₖ⁽⁻¹⁾}qₖ⁽⁻¹⁾+eₖ⁽⁻¹⁾=qₖ⁽⁰⁾+eₖ₋₁⁽⁰⁾−σⱼ², k=1, 2 . . . , m, qₖ₊₁⁽⁻¹⁾eₖ⁽⁻¹⁾=qₖ⁽⁰⁾eₖ⁽⁰⁾, k=1, 2, . . . , m−1, e₀⁽⁰⁾≡0, eₘ⁽⁻¹⁾≡0. If the singular value σⱼ is already known, a repetitive calculation is not necessary, and thus the amount of calculation can be reduced. However, these methods do not always have high numerical stability and high accuracy. The reason for this is that in both of the stqds transformation and the rpqds transformation, cancellation due to subtraction may occur. For example, in the stqds transformation, the number of significant digits may be only one even in double-precision calculation if qₖ⁽⁺¹⁾ is to be obtained in the case of qₖ⁽⁰⁾+eₖ₋₁⁽⁰⁾−σⱼ²˜eₖ₋₁⁽⁺¹⁾. In this case, if qₖ⁽⁰⁾eₖ⁽⁰⁾/qₖ⁽⁺¹⁾ is calculated, errors occur. In other words, eₖ⁽⁺¹⁾ cannot be accurately calculated. Furthermore, sequential calculation is requested, i.e., eₖ⁽⁺¹⁾ is necessary in order to obtain qₖ₊₁⁽⁺¹⁾, and qₖ⁽⁺¹⁾ is necessary in order to obtain eₖ⁽⁺¹⁾. Thus, a cancellation error occurred at one section spreads, and thus errors may increase. As a result, a numerically unstable situation also may be expected in which qₖ⁽⁺¹⁾≠0 in theory, but qₖ⁽⁺¹⁾=0 due to error accumulation, and thus overflow occurs in calculation of qₖ⁽⁰⁾eₖ⁽⁰⁾/qₖ⁽⁺¹⁾. If B⁽⁰⁾=the elements of B {b₂ₖ₋₁⁽⁰⁾, b₂ₖ⁽⁰⁾}, that is, {qₖ⁽⁰⁾, eₖ⁽⁰⁾} is given, σⱼ² and eₖ₋₁⁽⁺¹⁾ are uniquely determined, and thus this situation cannot be avoided. Since the rpqds transformation has a similar property, it is not considered that this transformation has reached a practical level. Although improved FORTRAN routine DSTEGR has been disclosed in LAPACK, the above-described problems are not completely solved.

(LV-Type Twisted Factorization)

Next, Miura Transformation, dLVv-type transformation, inverse Miura transformation used in LV-type twisted factorization will be described (see FIG. 14).

Miura transformation: {qₖ⁽⁰⁾,eₖ⁽⁰⁾} [symbol] {u₂ₖ₋₁⁽⁰⁾,u₂ₖ⁽⁰⁾}

stdLVv transformation: uₖ⁽⁰⁾ [symbol] uₖ⁽⁺¹⁾

rdLVv transformation: uₖ⁽⁰⁾ [symbol] uₖ⁽⁻¹⁾

inverse Miura transformation: {u₂ₖ₋₁^{(±1)},u₂ₖ^{(±1)}} [symbol] {qₖ^{(±1)},eₖ^{(±1)}}

First, Miura transformation will be described. This transformation is shown as:

$${u}_{2 k - 1}^{( 0 )} = \frac{{t}_{k}^{( 0 )}}{{δ}^{( 0 )}} , \\ k = 1 , 2 , … , m , \\ {u}_{2 k}^{( 0 )} = \frac{{e}_{k}^{( 0 )}}{{t}_{k}^{( 0 )}} , \\ k = 1 , 2 , … , m - 1 , \\ {t}_{k}^{( 0 )} ≡ \frac{{q}_{k}^{( 0 )}}{\frac{1}{{δ}^{( 0 )}} + {u}_{2 k - 2}^{( 0 )}} - 1 , \\ {u}_{0}^{( 0 )} ≡ 0 ,$$

where δ⁽⁰⁾ may be arbitrarily selected.

Next, dLVv-type transformation will be described. This transformation is further divided into stationary discrete Lotka-Volterra with variable step-size (stdLVv) transformation:

$${u}_{k}^{( + 1 )} = {u}_{k}^{( 0 )} \times \frac{1 + {δ}^{( 0 )} {u}_{k - 1}^{( 0 )}}{1 + {δ}^{( + 1 )} {u}_{k - 1}^{( + 1 )}} , \\ k = 1 , 2 , … , 2 m - 1 , \\ {u}_{0}^{( 0 )} ≡ 0 , \\ {u}_{0}^{( + 1 )} ≡ 0 , \\ and$$

reverse-time discrete Lotka-Volterra with variable step-size (rdLVv) transformation:

$${u}_{k}^{( - 1 )} = {u}_{k}^{( 0 )} \times \frac{1 + {δ}^{( 0 )} {u}_{k - 1}^{( 0 )}}{1 + {δ}^{( - 1 )} {u}_{k + 1}^{( - 1 )}} , \\ k = 1 , 2 , … , 2 m - 1 , \\ {u}_{0}^{( 0 )} ≡ 0 , \\ {u}_{2 m}^{( - 1 )} ≡ 0 ,$$

where δ^{(±1)} may be arbitrarily selected within a range satisfying

$$\frac{1}{{δ}^{( 0 )}} - \frac{1}{{δ}^{( n )}} = {σ}_{j}^{2} , \\ ( n = + 1 , - 1 ) .$$

Lastly, inverse Miura transformation will be described. This transformation is shown as:

$${q}_{k}^{( \pm 1 )} = \frac{( 1 + {δ}^{( \pm 1 )} {u}_{2 k - 2}^{( \pm 1 )} ) \times ( 1 + {δ}^{( \pm 1 )} {u}_{2 k - 1}^{( \pm 1 )} )}{{δ}^{( \pm 1 )}} , \\ k = 1 , 2 , … , m , \\ {e}_{k}^{( \pm 1 )} = {δ}^{( \pm 1 )} {u}_{2 k - 1}^{( \pm 1 )} {u}_{2 k}^{( \pm 1 )} , \\ k = 1 , 2 , … , m - 1$$

$${u}_{0}^{( \pm 1 )} ≡ 0.$$

In this manner, Cholesky decomposition can be performed as in qd-type transformation. A significant feature of discrete Lotka-Volterra-type transformation, not seen in qd-type transformation, is that the discrete Lotka-Volterra-type transformation has an arbitrary parameter. More specifically, δ⁽ⁿ⁾ can be arbitrarily set within a range satisfying σⱼ²=1/δ⁽⁰⁾−1/δ^{(±1)}. When δ⁽ⁿ⁾ is varied, an auxiliary variable uₖ⁽ⁿ⁾ also changes. However, it is possible to judge in advance whether or not cancellation errors or numerical instability occurs. This judgment may be implemented by an ‘if’ clause. In this case, calculation may be performed again after 6(n) is set again. Furthermore, if uₖ^{(±1)} is obtained, qₖ^{(±1)} and eₖ^{(±1)} are independently calculated by inverse Miura transformation, and thus errors do not spread. Herein, inverse Miura transformation may be referred to as Miura transformation, Miura transformation may be referred to as inverse Miura transformation, stdLVv transformation may be referred to as stLVv transformation, and rdLVv transformation may be referred to as rLVv transformation.

Herein, a more detailed example of a process according to LV-type twisted factorization will be described. FIGS. 15 to 20 are flowcharts showing an example of a process according to LV-type twisted factorization.

FIG. 15 is a diagram showing an example of the entire process of Cholesky decomposition.

(step S901) The Cholesky decomposition portion 21 performs Miura transformation. This process will be described later in detail.

(step S902) The Cholesky decomposition portion 21 sets 1/δ^{(±1)} to 1/δ⁽⁰⁾σⱼ².

(step S903) The Cholesky decomposition portion 21 performs the process of Procedure 1 described later.

(step S904) The Cholesky decomposition portion 21 performs the process of Procedure 2 described later.

(step S905) The Cholesky decomposition portion 21 judges whether or not qₖ⁽⁺¹⁾ and eₖ⁽⁺¹⁾ have been already computed. If qₖ⁽⁺¹⁾ and eₖ⁽⁺¹⁾ have been already computed, the series of processes of Cholesky decomposition end. If not, the procedure returns to step S901.

FIG. 16 is a flowchart showing a detailed process in step S903 of the flowchart in FIG. 15.

(step S1001) The Cholesky decomposition portion 21 judges whether or not qₖ⁽⁺¹⁾ and eₖ⁽⁺¹⁾ have been already computed. If qₖ⁽⁺¹⁾ and eₖ⁽⁺¹⁾ have been already computed, the procedure ends. If not, the procedure proceeds to step S1002.

(step S1002) The Cholesky decomposition portion 21 performs a process such as stdLVv transformation. This process will be described later in detail.

FIG. 17 is a flowchart showing a detailed process in step S904 of the flowchart in FIG. 15.

(step S1101) The Cholesky decomposition portion 21 judges whether or not qₖ⁽⁻¹⁾ and eₖ⁽⁻¹⁾ have been already computed. If qₖ⁽⁻¹⁾ and eₖ⁽⁻¹⁾ have been already computed, the procedure ends. If not, the procedure proceeds to step S1102.

(step S1102) The Cholesky decomposition portion 21 performs a process such as rdLVv transformation. This process will be described later in detail.

FIG. 18 is a flowchart showing a detailed process in step S901 of the flowchart in FIG. 15.

(step S1201) The Cholesky decomposition portion 21 determines 1/δ⁽⁰⁾. As described above, this value can be arbitrarily determined. If the computed singular values are taken as σ₁, σ₂, . . . in ascending order by size, for example, the Cholesky decomposition portion 21 first may set 1/δ⁽⁰⁾ to a value smaller than σ₁² (e.g., ‘1’, etc). Subsequently, if it is judged in step S1203 or the like that cancellation may occur, the Cholesky decomposition portion 21 may set 1/δ⁽⁰⁾ while successively incrementing j by 1, for example, set 1/δ⁽⁰⁾ to a value between σⱼ² and σⱼ₊₁² (j=1, 2, . . . ). It will be appreciated that the method for determining 1/δ⁽⁰⁾ is not limited to this.

(step S1202) The Cholesky decomposition portion 21 sets β1 to q₁⁽⁰⁾−1/δ⁽⁰⁾.

(step S1203) The Cholesky decomposition portion 21 judges whether or not the absolute value of β1 is larger than ε. If the absolute value of β1 is larger than ε, the procedure proceeds to step S1204. If not, the procedure returns to step S1201 where the process of determining 1/δ⁽⁰⁾ is performed again. Herein, also can be arbitrarily determined. For example, the machine epsilon may be used as ε. If ε is made larger, accuracy is improved. If ε is made smaller, accuracy becomes poor. Herein, the process performed in step S1203 is a process of judging the possibility of cancellation to occur. If the absolute value of β1 is not larger than ε, it will be judged that there is a possibility of cancellation to occur.

(step S1204) The Cholesky decomposition portion 21 sets β2 to q₁⁽⁰⁾/(1+δ⁽⁰⁾u₀⁽⁰⁾). This means that β2 has been set to q₀⁽⁰⁾, because u₀⁽⁰⁾=0 as described above.

(step S1205) The Cholesky decomposition portion 21 sets u₁⁽⁰⁾(1+δ⁽⁰⁾u₀⁽⁰⁾) to β1. The reason for this is that although β1 has been set to q₀⁽⁰⁾−1/δ⁽⁰⁾ in step S1202, u₀⁽⁰⁾=0 as described above, and thus β1 is equal to q₁⁽⁰⁾/(1+δ⁽⁰⁾u₀⁽⁰⁾)−1/δ⁽⁰⁾, and u₁⁽⁰⁾=u₂ₖ₋₁⁽⁰⁾|ₖ₌₁ is obtained by Miura transformation. Herein, since u₀⁽⁰⁾=0, (1+δ⁽⁰⁾u₀⁽⁰⁾)=1.

(step S1206) The Cholesky decomposition portion 21 sets a counter k to ‘1’.

(step S1207) The Cholesky decomposition portion 21 sets α1 to eₖ⁽⁰⁾/β1. As described above, β1 is u₂ₖ₋₁⁽⁰⁾, and thus α1=δ⁽⁰⁾u₂ₖ⁽⁰⁾ is obtained by Miura transformation performed on eₖ⁽⁰⁾/β1.

(step S1208) The Cholesky decomposition portion 21 sets α2 to α1+1. As shown in the description of step S1207, α2 is equal to 1+δ⁽⁰⁾u₂ₖ⁽⁰⁾.

(step S1209) The Cholesky decomposition portion 21 judges whether or not the absolute value of α2 is larger than ε. If the absolute value of α2 is larger than ε, the procedure proceeds to step S1210, If not, the procedure returns to step S1201 where the process of determining 1/δ⁽⁰⁾ is performed again. Herein, the process performed in step S1209 is a process of judging the possibility of cancellation to occur, as in step S1203. If the absolute value of α2 is not larger than ε, it will be judged that there is a possibility of cancellation to occur.

(step S1210) The Cholesky decomposition portion 21 computes α1×β2 and sets u₂ₖ⁽⁰⁾(1+δ⁽⁰⁾u₂ₖ₋₁⁽⁰⁾) to the computed value. The reason for this is that as described above, α1 is equal to δ⁽⁰⁾u₂ₖ⁽⁰⁾ and β2 is qₖ⁽⁰⁾/(1+δ⁽⁰⁾u₂ₖ₋₂⁽⁰⁾), and thus α1×β2=u₂ₖ⁽⁰⁾(1+δ⁽⁰⁾u₂ₖ₋₁⁽⁰⁾) is obtained by Miura transformation performed on α1×β2.

(step S1211) The Cholesky decomposition portion 21 sets β2 to qₖ₊₁⁽⁰⁾/α2. As described above, α2 is equal to 1+δ⁽⁰⁾u₂ₖ⁽⁰⁾, and thus β2 is qₖ₊₁⁽⁰⁾/(1+δ⁽⁰⁾u₂ₖ⁽⁰⁾). Accordingly, this means that k in β2 has been incremented by 1.

(step S1212) The Cholesky decomposition portion 21 sets β1 to β2−1/δ⁽⁰⁾. As described above, β2 is equal to qₖ₊₁⁽⁰⁾/(1+δ⁽⁰⁾u₂ₖ⁽⁰⁾), and thus β1 is qₖ₊₁⁽⁰⁾/(1+δ⁽⁰⁾u₂ₖ⁽⁰⁾)−1/δ⁽⁰⁾, and β1=u₂ₖ₊₁⁽⁰⁾ is obtained by Miura transformation. Accordingly, this means that k in β1 has been incremented by 1.

(step S1213) The Cholesky decomposition portion 21 judges whether or not the absolute value of β1 is larger than ε. If the absolute value of β1 is larger than ε, the procedure proceeds to step S1214. If not, the procedure returns to step S1201 where the process of determining 1/δ⁽⁰⁾ is performed again. Herein, the process performed in step S1213 is a process of judging the possibility of cancellation to occur, as in step S1203. If the absolute value of β1 is not larger than ε, it will be judged that there is a possibility of cancellation to occur.

(step S1214) The Cholesky decomposition portion 21 computes α2×β1 and sets u₂ₖ₊₁⁽⁰⁾(1+δ⁽⁰⁾u₂ₖ⁽⁰⁾) to the computed value. The reason for this is that α2 is equal to 1+δ⁽⁰⁾u₂ₖ⁽⁰⁾, and β1 is equal to u₂ₖ₊₁⁽⁰⁾, as described above.

(step S1215) The Cholesky decomposition portion 21 increments the counter k by 1.

(step S1216) The Cholesky decomposition portion 21 judges whether or not the counter k is equal to m. If the counter k is equal to m, the series of processes end. If not, the procedure returns to step S1207.

In this manner, u₂ₖ₊₁⁽⁰⁾(1+δ⁽⁰⁾u₂ₖ⁽⁰⁾) and u₂ₖ⁽⁰⁾(1+δ⁽⁰⁾u₂ₖ₋₁⁽⁰⁾) are computed. These values may be temporarily stored in a memory (not shown) or the like included in the Cholesky decomposition portion 21.

FIG. 19 is a flowchart showing a detailed process in step S1002 of the flowchart in FIG. 16.

(step S1301) The Cholesky decomposition portion 21 sets α2 to 1+δ⁽⁺¹⁾u₀⁽⁺¹⁾. This means that α2 has been set to ‘1’, because u₀⁽⁺¹⁾=0 as described above.

(step S1302) The Cholesky decomposition portion 21 sets β1 to u₁⁽⁰⁾(1+δ⁽⁰⁾u₀⁽⁰⁾)/(1+δ⁽⁺¹⁾u₀⁽⁺¹⁾). Herein, the value computed in step S1205 is used as u₁⁽⁰⁾(1+δ⁽⁰⁾u₀⁽⁰⁾). As described above, u₀⁽⁺¹⁾=0. Furthermore, stdLVv transformation on the formula of β1 means setting β1 to u₁⁽⁺¹⁾.

(step S1303) The Cholesky decomposition portion 21 sets a counter k to ‘1’.

(step S1304) The Cholesky decomposition portion 21 sets α1 to β1+1/δ⁽⁺¹⁾.

(step S1305) The Cholesky decomposition portion 21 judges whether or not the absolute value of α1 is larger than ε. If the absolute value of α1 is larger than ε, the procedure proceeds to step S1306. If not, the procedure proceeds to Procedure 2 (step S904) in the flowchart in FIG. 15. Herein, the process performed in step S1305 is a process of judging the possibility of cancellation to occur, as in step S1203. If the absolute value of α1 is not larger than ε, it will be judged that there is a possibility of cancellation to occur.

(step S1306) The Cholesky decomposition portion 21 sets β2 to u₂ₖ⁽⁰⁾(1+δ⁽⁰⁾u₂ₖ₋₁⁽⁰⁾)/α1. Herein, the value computed in step S1210 is used as u₂ₖ⁽⁰⁾(1+δ⁽⁰⁾u₂ₖ₋₁⁽⁰⁾). Furthermore, stdLVv transformation on the formula of β2 means setting β2 to δ⁽⁺¹⁾u₂ₖ⁽⁺¹⁾.

(step S1307) The Cholesky decomposition portion 21 computes α1×α2. As described above, α1 is equal to β1+1/δ⁽⁺¹⁾=u₂ₖ₋₁⁽⁺¹⁾+1/δ⁽⁺¹⁾, and α2 is equal to 1+δ⁽⁺¹⁾u₂ₖ₋₂⁽⁺¹⁾, and thus α1×α2=qₖ⁽⁺¹⁾ is obtained by inverse Miura transformation performed on α1×α2. Accordingly, the Cholesky decomposition portion 21 computes α1×α2 and sets qₖ⁽⁺¹⁾ to the computed value.

(step S1308) The Cholesky decomposition portion 21 sets α2 to 1+β2. As described above, β2 is equal to δ⁽⁺¹⁾u₂ₖ⁽⁺¹⁾, and thus α2 is 1+δ⁽⁺¹⁾u₂ₖ⁽⁺¹⁾. Accordingly, this means that k in α2 has been incremented by 1.

(step S1309) The Cholesky decomposition portion 21 judges whether or not the absolute value of α2 is larger than ε. If the absolute value of α2 is larger than ε, the procedure proceeds to step S1310. If not, the procedure proceeds to Procedure 2 (step S904) in the flowchart in FIG. 15. Herein, the process performed in step S1309 is a process of judging the possibility of cancellation to occur, as in step S1203. If the absolute value of α2 is not larger than c, it will be judged that there is a possibility of cancellation to occur.

(step S1310) The Cholesky decomposition portion 21 computes β1×β2. As described above, β1 is equal to u₂ₖ₋₁⁽⁺¹⁾, and β2 is equal to δ⁽⁺¹⁾u₂ₖ⁽⁺¹⁾, and thus β1×β2=eₖ⁽⁺¹⁾ is obtained by inverse Miura transformation performed on β1×β2. Accordingly, the Cholesky decomposition portion 21 computes β1×β2 and sets eₖ⁽⁺¹⁾ to the computed value.

(step S1311) The Cholesky decomposition portion 21 sets β1 to u₂ₖ₊₁⁽⁰⁾(1+δ⁽⁰⁾u₂ₖ⁽⁰⁾)/α2. Herein, the value computed in step S1214 is used as u₂ₖ₊₁⁽⁰⁾(1+δ⁽⁰⁾u₂ₖ⁽⁰⁾). Furthermore, stdLVv transformation on the formula of β1 means setting β1 to u₂ₖ₊₁⁽⁺¹⁾. Accordingly, this means that k in β1 has been incremented by 1.

(step S1312) The Cholesky decomposition portion 21 increments the counter k by 1.

(step S1313) The Cholesky decomposition portion 21 judges whether or not the counter k is equal to m. If the counter k is equal to m, the procedure proceeds to step S1314. If not, the procedure returns to step S1304.

(step S1314) The Cholesky decomposition portion 21 computes α2×(β1+1/δ⁽⁺¹⁾). This is the same as a process in which after α1 is updated in step S1304, α1×α2 is calculated in step S1307. Accordingly, the Cholesky decomposition portion 21 computes α2×(β1+1/δ⁽⁺¹⁾) and sets q₁⁽⁺¹⁾ to the computed value. In this manner, the process of computing qₖ⁽⁺¹⁾ and eₖ⁽⁺¹⁾ by performing stdLVv transformation and inverse Miura transformation on the result obtained by Miura transformation ends. These values may be temporarily stored in a memory (not shown) or the like included in the Cholesky decomposition portion 21.

FIG. 20 is a flowchart showing a detailed process in step S1102 of the flowchart in FIG. 17.

(step S1401) The Cholesky decomposition portion 21 sets β1 to u₂ₘ₋₁⁽⁰⁾(1+δ⁽⁰⁾u₂ₘ₋₂⁽⁰⁾)/(1+δ⁽⁻¹⁾u₂ₘ⁽⁻¹⁾). Herein, the value computed in step S1214 is used as u₂ₘ₋₁⁽⁰⁾(1+δ⁽⁰⁾u₂ₘ₋₂⁽⁰⁾). As described above, u₂ₘ⁽⁻¹⁾=0. Furthermore, rdLVv transformation on the formula of β1 means setting β1 to u₂ₘ₋₁⁽⁻¹⁾.

(step S1402) The Cholesky decomposition portion 21 sets a counter k to ‘m−1’.

(step S1403) The Cholesky decomposition portion 21 sets α1 to β1+1/δ⁽⁻¹⁾.

(step S1404) The Cholesky decomposition portion 21 judges whether or not the absolute value of α1 is larger than ε. If the absolute value of α1 is larger than ε, the procedure proceeds to step S1405. If not, the procedure returns to Miura transformation (step S901) in the flowchart in FIG. 15. Herein, the process performed in step S1404 is a process of judging the possibility of cancellation to occur, as in step S1203. If the absolute value of α1 is not larger than ε, it will be judged that there is a possibility of cancellation to occur.

(step S1405) The Cholesky decomposition portion 21 sets β2 to u₂ₖ⁽⁰⁾(1+δ⁽⁰⁾u₂ₖ₋₁⁽⁰⁾)/α1. Herein, the value computed in step S1210 is used as u₂ₖ⁽⁰⁾(1+δ⁽⁰⁾u₂ₖ₋₁⁽⁰⁾). Furthermore, rdLVv transformation on the formula of β2 means setting β2 to δ⁽⁻¹⁾u₂ₖ⁽⁻¹⁾.

(step S1406) The Cholesky decomposition portion 21 sets α2 to 1+β2. As described above, β2 is equal to δ⁽⁻¹⁾u₂ₖ⁽⁻¹⁾, and thus α2 is 1+δ⁽⁻¹⁾u₂ₖ⁽⁻¹⁾.

(step S1407) The Cholesky decomposition portion 21 judges whether or not the absolute value of α2 is larger than ε. If the absolute value of α2 is larger than ε, the procedure proceeds to step S1408. If not, the procedure returns to Miura transformation (step S901) in the flowchart in FIG. 15. Herein, the process performed in step S1407 is a process of judging the possibility of cancellation to occur, as in step S1203. If the absolute value of α2 is not larger than ε, it will be judged that there is a possibility of cancellation to occur.

(step S1408) The Cholesky decomposition portion 21 computes α1×α2. As described above, α1 is equal to β1×α2=qₖ₊₁⁽⁻¹⁾, and α2 is equal to 1+δ⁽⁻¹⁾u₂ₖ⁽⁻¹⁾, and thus α1×α2=qₖ₊₁⁽⁻¹⁾ is obtained by inverse Miura transformation performed on α1×α2. Accordingly, the Cholesky decomposition portion 21 computes α1×α2 and sets qₖ₊₁⁽⁻¹⁾ to the computed value.

(step S1409) The Cholesky decomposition portion 21 sets β1 to u₂ₖ₋₁⁽⁰⁾(1+δ⁽⁰⁾u₂ₖ₋₂⁽⁰⁾)/α2. Herein, the value computed in steps S1205 and S1214 is used as u₂ₖ₋₁⁽⁰⁾(1+δ⁽⁰⁾u₂ₖ₋₂⁽⁰⁾). Furthermore, stdLVv transformation on the formula of β1 means setting β1 to u₂ₖ₋₁⁽⁻¹⁾. Accordingly, this means that k in β1 has been decremented by 1.

(step S1410) The Cholesky decomposition portion 21 computes β1×β2. As described above, β1 is equal to u₂ₖ₋₁⁽⁻¹⁾, and β2 is equal to δ⁽⁻¹⁾u₂ₖ⁽⁻¹⁾, and thus β1×β2=eₖ⁽⁻¹⁾ is obtained by inverse Miura transformation performed on β1×β2. Accordingly, the Cholesky decomposition portion 21 computes β1×β2 and sets eₖ⁽⁻¹⁾ to the computed value.

(step S1411) The Cholesky decomposition portion 21 decrements the counter k by 1.

(step S1412) The Cholesky decomposition portion 21 judges whether or not the counter k is equal to 0. If the counter k is equal to 0, the procedure proceeds to step S1413. If not, the procedure returns to step S1403.

(step S1413) The Cholesky decomposition portion 21 computes β1+1/δ⁽⁻¹⁾. This is the same as a process in which after α1 is updated in step S1403, α1×α2 is calculated in step S1408. The reason for this is that in this case, α2 is 1. Accordingly, the Cholesky decomposition portion 21 computes β1+1/δ⁽⁻¹⁾ and sets q₁⁽⁻¹⁾ to the computed value. In this manner, the process of computing qₖ⁽⁻¹⁾ and eₖ⁽⁻¹⁾ by performing rdLVv transformation and inverse Miura transformation on the result obtained by Miura transformation ends. These values may be temporarily stored in a memory (not shown) or the like included in the Cholesky decomposition portion 21.

Herein, it is possible to compute a singular vector corresponding to one singular value, in the process in the flowchart in FIG. 15. Thus, if singular vectors corresponding to all singular values are to be computed, the Cholesky decomposition portion 21 repeats the process in the flowchart in FIG. 15 as many times as the number of the singular values.

In order to reduce memory consumption, an array for the auxiliary variable uₖ⁽ⁿ⁾ does not necessarily have to be prepared. It is possible to reduce the memory consumption and the calculation amount, by securing a memory area for 1+δ⁽⁰⁾u⁽⁰⁾ and using this value throughout the steps of Miura transformation, dLVv-type transformation, and inverse Miura transformation. Accordingly, errors are also reduced.

Herein, errors will be described. If a person can perform computation in an ideal situation, that is, can compute an infinite number of digits, both qd-type twisted factorization and LV-type twisted factorization can be used without any problem. However, an attention is necessary for calculation with a computer. On a computer, which can compute only a finite number of digits, even if a mathematically correct calculation is used, a correct result cannot be always obtained. Moreover, unexpected numerical problems may occur (e.g., the calculation may not end no matter how long the calculation is performed).

Known examples of errors in computer calculation include rounding errors and cancellation errors. A single rounding error is not a Significant error because it is different from a true value at most only in the last significant digits. If at least one of addition, multiplication, and division is performed on two real numbers having different exponent parts, a rounding error still occurs, but no error greater than that occurs. Moreover, even in a case where an operation causing this sort of rounding errors is repeated, if the rounding mode is near (round), extreme error accumulation due to automatic rounding-up or rounding-off hardly occurs. Thus, in many methods for calculating numerical values, a special attention is hardly paid to rounding errors caused by at least one of addition, multiplication, and division. Also in the case of singular value calculation according to a dLVs routine, rounding errors do not increase.

The problem is cancellation caused by subtraction of real numbers having the same sign and addition of real numbers having different signs. After the value becomes 0 due to a cancellation error, if division is performed using this value, 0 is taken as the denominator, which is an irregular form, and thus the calculation cannot be performed. In such a situation, the calculation may not end no matter how long the calculation is performed. Calculation of subtraction and then division is performed in both of qd-type twisted factorization and LV-type twisted factorization, and thus a sufficient attention has to be paid to cancellation errors.

In LV-type twisted factorization, it is possible to judge whether or not the above-described cancellation error is contained, based on whether or not a value obtained by subtraction is small. In the case of qd-type twisted factorization, even if it is known that a cancellation error is contained, the error cannot be avoided. The reason for this is that if {qₖ⁽⁰⁾, eₖ⁽⁰⁾} is given as an initial value, then σⱼ is uniquely determined, and {qₖ^{(±1)}, eₖ^{(±1)}} is also uniquely determined. In other words, qd-type twisted factorization is a calculation method having no arbitrary parameter, that is, having no degree of freedom.

In contrast, LV-type twisted factorization has a parameter δ⁽⁰⁾ that can be freely set, and thus the auxiliary variable uₖ⁽ⁿ⁾ can be variously changed (see FIGS. 21A and 21B). More specifically, {qₖ^{(±1)}, eₖ⁽⁻¹⁾} can be calculated in various routes. Thus, even if cancellation occurs, the cancellation can be avoided. The influence of cancellation is checked by judgment on the conditions in FIGS. 18 to 20, and if the condition that the absolute value of a value obtained by subtraction is larger than the small number is not satisfied, the procedure returns to setting of the parameter δ⁽⁰⁾. This process is repeated until the condition is satisfied. Herein, in a case where more emphasis is placed on speed than accuracy, an exceptional process may be performed if the condition is not satisfied a several number of times (if qₖ⁽⁺¹⁾=0 or qₖ⁽⁻¹⁾=0).

If Cholesky decomposition can be performed using qd-type twisted factorization or LV-type twisted factorization, the twisted matrix Nₖ can be computed as described above. Then, xⱼ can be computed by solving Nₖ^{T}xⱼ=eₖ of the matrix Nₖ.

Herein, xⱼ is normalized by replacing xⱼ as

$${x}_{j} ← \frac{{x}_{j}}{‖ {x}_{j} ‖} .$$

In this manner, the right singular vector xⱼ can be obtained. The right orthogonal matrix V_{B} can be computed according to V_{B}=(x₁, x₂, . . . , xₘ) using this right singular vector xⱼ.

Furthermore, as described above, U_{B}=BV_{B}Σ⁻¹. Thus, if V_{B} is obtained, the left orthogonal matrix can be computed because the bidiagonal matrix B and the matrix Σ whose diagonal elements are represented as the singular values are already known. More specifically, if the singular value σⱼ is not 0, then

$${y}_{j} = \frac{{Bx}_{j}}{{σ}_{j}} .$$

On the other hand, if the singular value σⱼ is 0, then yⱼ can be computed by solving B^{T}yⱼ=0. Herein, as in the case of xⱼ, yⱼ is normalized by replacing yⱼ as

$${y}_{j} ← \frac{{y}_{j}}{‖ {y}_{j} ‖} .$$

In this manner, the left singular vector yⱼ can be obtained. The left orthogonal matrix U_{B} can be computed according to U_{B}=(y₁, y₂, . . . , yₘ) using this left singular vector yⱼ. In this manner, singular value decomposition on the bidiagonal matrix B is performed. Herein, after this process, processes using inverse iteration or Gram-Schmidt method may be performed as described above. In this example, the case was described in which the right orthogonal matrix V_{B} is computed first, but the eigenvector of BB^{T}, that is, the left orthogonal matrix U_{B} may be computed first.

Furthermore, if singular value decomposition on the bidiagonal matrix B can be performed, singular value decomposition on the matrix A is also performed as follows.

$$\begin{matrix}A = \{ \begin{matrix}{U}_{H} ( B 0 ) {V}_{H}^{T} & ( {l}_{1} \leq {l}_{2} ) \\ {U}_{H} ( \begin{matrix}B \\ 0\end{matrix} ) {V}_{H}^{T} & ( {l}_{1} \geq {l}_{2} )\end{matrix} \\ = \{ \begin{matrix}{U}_{H} ( {U}_{B} Σ {V}_{B}^{T} 0 ) {V}_{H}^{T} & ( {l}_{1} \leq {l}_{2} ) \\ {U}_{H} ( \begin{matrix}{U}_{B} Σ {V}_{B}^{T} \\ 0\end{matrix} ) {V}_{H}^{T} & ( {l}_{1} \geq {l}_{2} )\end{matrix} \\ = \{ \begin{matrix}{U}_{H} {U}_{B} ( Σ 0 ) {( \begin{matrix}{V}_{B} & 0 \\ 0 & 1\end{matrix} )}^{T} {V}_{H}^{T} & ( {l}_{1} \leq {l}_{2} ) \\ {U}_{H} ( \begin{matrix}{U}_{B} & 0 \\ 0 & 1\end{matrix} ) ( \begin{matrix}Σ \\ 0\end{matrix} ) {V}_{B}^{T} {V}_{H}^{T} & ( {l}_{1} \geq {l}_{2} )\end{matrix} \\ = \{ \begin{matrix}{U}_{A} ( Σ 0 ) {V}_{A}^{T} & ( {l}_{1} \leq {l}_{2} ) \\ {U}_{A} ( \begin{matrix}Σ \\ 0\end{matrix} ) {V}_{A}^{T} & ( {l}_{1} \geq {l}_{2} )\end{matrix}\end{matrix}$$

As described above, the singular vector computing portion 19 computes the singular vectors of the upper bidiagonal matrix B, using the singular values of the upper bidiagonal matrix B stored in the singular value storage portion 18 and the upper bidiagonal matrix B stored in the diagonal matrix storage portion 13. First, the Cholesky decomposition portion 21 reads out the upper bidiagonal matrix B from the diagonal matrix storage portion 13, and reads out the singular values of the upper bidiagonal matrix B from the singular value storage portion 18. Then, the Cholesky decomposition portion 21 performs the Cholesky decomposition process by performing transformations as shown in the flowchart in FIG. 22. Herein, a case will be described in which LV-type twisted factorization is used.

The Cholesky decomposition portion 21 first obtains qₖ⁽⁰⁾ and eₖ⁽⁰⁾ based on the value of each element of the upper bidiagonal matrix B. Then, the Cholesky decomposition portion 21 sequentially obtains u₁⁽⁰⁾, u₂⁽⁰⁾, and the like by performing Miura transformation (step S801).

Next, the Cholesky decomposition portion 21 sequentially obtains u₁⁽⁺¹⁾ and the like by performing stdLVv transformation, using uₖ⁽⁰⁾ obtained in the Miura transformation (step S802). Furthermore, the Cholesky decomposition portion 21 sequentially obtains u₂ₘ₋₁⁽⁻¹⁾ and the like by performing rdLVv transformation, using uₖ⁽⁰⁾ obtained in the Miura transformation (step S803).

Lastly, the Cholesky decomposition portion 21 sequentially obtains q₁^{(±1)}, e₁^{(±1)}, and the like by performing inverse Miura transformation, using uₖ⁽⁺¹⁾ obtained in the stdLVv transformation and uₖ⁽⁻¹⁾ obtained in the rdLVv transformation (step S804). If qₖ^{(±1)} and eₖ^{(±1)} are obtained, that is, if the upper bidiagonal matrix B⁽⁺¹⁾ and the lower bidiagonal matrix B⁽⁻¹⁾ are obtained, the Cholesky decomposition portion 21 passes them to the first singular vector computing portion 22. Herein, it is assumed that the Cholesky decomposition portion 21 performs Cholesky decomposition on each singular value.

In this example, the Cholesky decomposition process was described using the flowchart in FIG. 22, for the sake of convenience of this description, but it will be appreciated that processes may be performed as shown in the flowcharts in FIGS. 15 to 20.

The first singular vector computing portion 22 reads out the singular values from the singular value storage portion 18, and determines k using Equation 10. The first singular vector computing portion 22 uses k to obtain a twisted matrix Nₖ according to qₖ^{(±1)} and eₖ^{(±1)}, and computes xⱼ by solving Nₖ^{T}xⱼ=eₖ(step S302).

Next, the first singular vector computing portion 22 normalizes the computed xⱼ to obtain a right singular vector xⱼ, and stores the right singular vector xⱼ in the singular vector storage portion 20 (step S303). Then, the first singular vector computing portion 22 passes the computed right singular vector xⱼ to the second singular vector computing portion 23. Herein, the first singular vector computing portion 22 can compute all right singular vectors by performing the process of computing and normalizing xⱼ on each singular value.

The second singular vector computing portion 23 reads out the upper bidiagonal matrix B from the diagonal matrix storage portion 13, and reads out the singular values of the upper bidiagonal matrix B from the singular value storage portion 18. Then, the second singular vector computing portion 23 computes yⱼ by solving yⱼ=Bxⱼ/σⱼ or B^{T}yⱼ=0, using the right singular vector xⱼ received from the first singular vector computing portion 22, the upper bidiagonal matrix B, and the singular value (step S304). Next, as in the case of the right singular vector xⱼ, the second singular vector computing portion 23 normalizes the computed yⱼ to obtain a left singular vector yⱼ, and stores the left singular vector yⱼ in the singular vector storage portion 20 (step S305). In this manner, the computation of the singular vector ends. Herein, the second singular vector computing portion 23 can compute all left singular vectors by performing the process of computing and normalizing yⱼ on each singular value.

Subsequently, the singular vectors of the matrix A stored in the matrix storage portion 11 may be computed. The method for computing the singular vectors is as described above.

Furthermore, the singular value decomposition apparatus 1 may include an output portion (not shown) that outputs the singular values computed by the singular value computing portion 17 and the singular vectors computed by the singular vector computing portion 19. Herein, the output by the output portion (not shown) may refer to, for example, displaying the singular values and the like on a display device (e.g., a CRT, a liquid crystal display, etc.), transmission of the singular values and the like via a communication line to a given device, printing of the singular values and the like using a printer, or accumulation of the singular values and the like in a storage medium. Herein, the output portion may or may not include an output device (e.g., a display device, a printer, etc.). Furthermore, the output portion may be realized as a hardware, or may be realized as software such as a driver that drives the device.

In this example, the case was described in which the Cholesky decomposition portion 21 performs Cholesky decomposition by LV-type twisted factorization, but the Cholesky decomposition portion 21 may perform Cholesky decomposition by qd-type twisted factorization. For example, the Cholesky decomposition portion 21 may check the distribution of the computed singular values, and use qd-type twisted factorization if the singular values are not densely distributed.

Furthermore, in the description above, the case was described in which the matrix B is an upper bidiagonal matrix. However, even if the matrix B is a lower bidiagonal matrix, singular value decomposition can be performed in a similar manner by transforming the matrix B into an upper bidiagonal matrix. For example, if a matrix C is a lower bidiagonal matrix, an upper bidiagonal matrix B=C^{T}. If singular value decomposition is performed on the upper bidiagonal matrix B as B=UΣV^{T}, then C=B^{T}=(UΣV^{T})^{T}=VΣU^{T}. It is shown that in the singular value decomposition of the lower bidiagonal matrix, the singular values are the same as those of the upper bidiagonal matrix B, and the left and right singular vectors are reversed.

On the other hand, also as for the lower bidiagonal matrix C, the matrix dividing portion 14 and the like may divide the lower bidiagonal matrix C, the singular value decomposition portion 15 may perform singular value decomposition on lower bidiagonal matrices after the division, and the singular value computing portion 17 may compute singular values of the lower bidiagonal matrix C using a result of the singular value decomposition. Furthermore, the singular vector computing portion 19 may perform Cholesky decomposition on the lower bidiagonal matrix C and the singular values thereof so as to compute singular vectors corresponding to the singular values.

In the description above, the case was described in which the singular value computing portion 17 computes all singular values, but only a part of the singular values may be computed. For example, in FIG. 13, the singular value computing portion 17 has to compute all singular values up to the process of computing those of the matrices B₁ and B₂. However, in computation of the singular values of the upper bidiagonal matrix B based on the matrices B₁ and B₂, only necessary singular values may be computed. Accordingly, the singular value computing portion 17 may be a portion that computes at least one singular value of the bidiagonal matrix B. In this case, an extra process accompanying computation of unnecessary singular values does not have to be performed, and thus the processing load can be reduced. If only a part of the singular values are to be computed in this manner, for example, the calculation time for a process of computing the singular values of the upper bidiagonal matrix B can be approximately (1+k/m)/2 times shorter than the original calculation time. Herein, m is a matrix size, and k is the number of singular values that are to be obtained.

In the description above, the case was described in which the singular vector computing portion 19 computes all singular vectors corresponding to the computed singular values. However, as shown in the description above, the process of computing a singular vector may be performed for each singular value. Accordingly, the singular vector computing portion 19 may be a portion that computes at least one singular vector of the bidiagonal matrix B. In this manner, the singular vector computing portion 19 can compute only necessary singular vectors, and does not have to perform an extra process accompanying computation of unnecessary singular vectors, and thus the processing load can be reduced.

Next, parallel processing in the singular value decomposition apparatus 1 according to this embodiment will be described.

In the singular value decomposition apparatus 1 according to this embodiment, in calculation of singular values and calculation of singular vectors, the processes can be performed in parallel. For example, as shown in FIG. 23, in the singular value decomposition apparatus 1, parallel processing may be performed in each of the singular value decomposition portion 15, the singular value computing portion 17, the Cholesky decomposition portion 21, the first singular vector computing portion 22, and the second singular vector computing portion 23.

The singular value decomposition portion 15 may include multiple singular value decomposition units 15a and 15b, and the multiple singular value decomposition units 15a and 15b may perform, in parallel, the process of computing singular values and matrix elements of bidiagonal matrices after division. For example, in FIG. 13, the singular value decomposition unit 15a may perform singular value decomposition on the matrices B₁₁₁, B₁₁₂, B₁₂₁, and B₁₂₂, and the singular value decomposition unit 15b may perform singular value decomposition on the matrices B₂₁₁, B₂₁₂, B₂₂₁, and B₂₂₂.

The singular value computing portion 17 may include multiple singular value computing units 17a and 17b, and the multiple singular value computing units 17a and 17b may perform, in parallel, the process of computing singular values and matrix elements of bidiagonal matrices that are division origins. For example, in FIG. 13, the singular value computing unit 17a may perform the process of computing singular values and the like of the matrices B11, B₁₂, B₁, and B, and the singular value computing unit 17b may perform the process of computing singular values and the like of the matrices B₂₁, B₂₂, and B₂.

The Cholesky decomposition portion 21 may include multiple Cholesky decomposition units 21a and 21b, and the multiple Cholesky decomposition units 21a and 21b may perform, in parallel, the process of performing Cholesky decomposition on the bidiagonal matrix B. For example, the Cholesky decomposition unit 21a may perform the process of Cholesky decomposition on half singular values, and the Cholesky decomposition unit 21b may perform the process of Cholesky decomposition on the other half singular values.

The first singular vector computing portion 22 may include multiple first singular vector computing units 22a and 22b, and the multiple first singular vector computing units 22a and 22b may perform, in parallel, the process of computing singular vectors. For example, the first singular vector computing unit 22a may perform the process of computing singular vectors for the singular values subjected to the Cholesky decomposition performed by the Cholesky decomposition unit 21a, and the first singular vector computing unit 22b may perform the process of computing singular vectors for the singular values subjected to the Cholesky decomposition performed by the Cholesky decomposition unit 21b.

The second singular vector computing portion 23 may include multiple second singular vector computing units 23a and 23b, and the multiple second singular vector computing units 23a and 23b may perform, in parallel, the process of computing singular vectors. For example, the second singular vector computing unit 23a may perform the process of computing singular vectors corresponding to the singular vectors computed by the first singular vector computing unit 22a, and the second singular vector computing unit 23b may perform the process of computing singular vectors corresponding to the singular vectors computed by the first singular vector computing unit 22b.

Herein, the multiple singular value computing units 17a and 17b of the singular value computing portion 17 may perform, in parallel, the process of computing the singular values and the matrix elements of the matrix B₀ that is the division origin based on the singular values and the matrix elements of the two matrices B₁ and B₂ after the division shown in FIG. 10. Hereinafter, this process will be described.

First, Equation 2 shows that the process of obtaining the singular values can be performed in parallel. Herein, Equation 5 is rewritten as follows.

$$\vert {\hat{z}}_{i} \vert = \sqrt{( {\hat{σ}}_{i}^{2} - {d}_{i}^{2} ) {\prod }_{k = 1}^{i - 1} \frac{( {\hat{σ}}_{k}^{2} - {d}_{i}^{2} )}{( {d}_{k}^{2} - {d}_{i}^{2} )} {\prod }_{k = i + 1}^{n} \frac{( {\hat{σ}}_{k}^{2} - {d}_{i}^{2} )}{( {d}_{k}^{2} - {d}_{i}^{2} )}} \qquad Equation 11$$

Equation 11 shows that in order to solve Equation 5, a portion of Equation 11 corresponding to a part of the singular values is computed first, and then multiplied by a portion of Equation 11 corresponding to the other singular values, and thus finally |\hat{Z}ᵢ| can be computed. Accordingly, the singular value computing units 17a and 17b, first, read out the singular values and the matrix elements of the two matrices B₁ and B₂ from the singular value decomposition storage portion 16, and read out two elements generated at the time of division of a matrix into the two matrices B₁ and B₂, from the diagonal matrix storage portion 13. It is possible to obtain zᵢ using the read matrix elements and two elements. Subsequently, each of the singular value computing units 17a and 17b uses Equation 2 to compute singular values that are to be computed by that singular value computing unit. This process can be performed in parallel.

Next, the singular value computing unit 17a solves a part of Equation 11 that can be solved using the computed singular values. In a similar manner, the singular value computing unit 17b also solves a part of Equation 11 that can be solved using the computed singular values. Then, the singular value computing units 17a and 17b exchange the calculated values, and multiply these values by the values calculated in advance, so as to finally calculate the value of Equation 11. In this manner, the singular value computing units 17a and 17b can perform, in parallel, the process of solving Equation 11.

Next, each of the singular value computing units 17a and 17b uses Equation 4 to calculate singular vectors corresponding to the singular values computed by that singular value computing unit. In this manner, the singular value computing units 17a and 17b can also perform, in parallel, the process of calculating the right orthogonal matrix V_{M}.

Subsequently, the singular value computing unit 17a or the singular value computing unit 17b calculates the matrix elements of the matrix B₀ using Equations 6 to 9, and thus the process of computing the singular values and the matrix elements of the matrix B₀ that is the division origin ends. In this manner, the process of computing the singular values and the matrix elements of the matrix B₀ that is the division origin based on the singular values and the matrix elements of the two matrices B₁ and B₂ after the division can be performed in parallel by the singular value computing units 17a and 17b.

In this sort of parallel processing in each constituent element, if each unit uses a memory in which information of singular values and the like is stored, multiple units may use the same memory, that is, a shared memory, or the units may respectively use different memories.

In this example, the case was described with reference to FIG. 23, in which the singular value decomposition portion 15, the singular value computing portion 17, and the like perform parallel processing using two units. However, the singular value decomposition portion 15, the singular value computing portion 17, and the like may include three or more units that perform parallel processing. Furthermore, the case was described in which parallel processing is performed in each of the singular value decomposition portion 15, the singular value computing portion 17, the Cholesky decomposition portion 21, the first singular vector computing portion 22, and the second singular vector computing portion 23. However, parallel processing may be not performed in one or more arbitrary units. For example, parallel processing may be not performed in the singular value decomposition portion 15.

Furthermore, the parallel processing may be performed in one apparatus using two or more CPUs or the like, or may be performed in two or more apparatuses. For example, as shown in FIG. 24, an apparatus A and an apparatus B may respectively include the singular value decomposition units 15a and 15b, and the apparatuses may perform singular value decomposition in parallel. In this case, a singular value decomposition portion 15-1 including the singular value decomposition unit 15a in the apparatus A and a singular value decomposition portion 15-2 including the singular value decomposition unit 15b in the apparatus B constitute the singular value decomposition portion 15. Accordingly, the singular value decomposition apparatus 1 has a system constituted by the apparatus A and the apparatus B. In this example, the parallel processing by the singular value decomposition portion 15 was described, but the singular value computing portion 17, the Cholesky decomposition portion 21, and the like also may perform parallel processing using two or more apparatuses.

[Application to Image Processing of Restoring Two-Dimensional Images to a Three-Dimensional Image]

Next, a case will be described in which singular value decomposition is applied to image processing of restoring two-dimensional images of an object to a three-dimensional image.

The processing of restoring multiple two-dimensional images to a three-dimensional image is performed following the steps below:

(1) a step of extracting feature points from the two-dimensional images;
(2) a step of calculating data relating to shape (three-dimensional coordinate data of the feature points of the original object) and rotation (transform from the three-dimensional data to the feature point data) based on the feature point data; and
(3) a step of performing visualization based on the shape and rotation data.

Hereinafter, the steps (1) and (2) will be described with reference to the flowchart in FIG. 25. Herein, the two-dimensional image may be, for example, a two-dimensional image read by an optical reading device such as a scanner, a digital still camera, or a digital video camera, or the like.

In step S5001, coordinates (xᵢ^{j}, yᵢ^{j}) of feature points i (i=1, . . . , n, n is an integer of 2 or more) are extracted from two-dimensional images j (j=1, . . . , m, m is an integer of 3 or more). The two-dimensional images that are handled are preferably weak central projection images. At that time, the following equation is obtained.

$$( \begin{matrix}{x}_{i}^{j} \\ {y}_{i}^{j}\end{matrix} ) = {s}_{j} ( \begin{matrix}{r}_{1 , j}^{T} \\ {r}_{2 , j}^{T}\end{matrix} ) ( \begin{matrix}{X}_{i} \\ {Y}_{i} \\ {Z}_{i}\end{matrix} )$$

Herein, sⱼ is the scale of the j^{th} image with respect to the scale of the object, r_{1,j} and r_{2,j} are respectively the first and the second row vectors of the rotation matrix of the j^{th} camera coordinate system with respect to the object coordinate system, and (Xᵢ, Yᵢ, Zᵢ)^{T} are three-dimensional coordinates of the i^{th} point. The scale of the object is set to be the same as that of the first image (s₁=1). The posture of the coordinate system of the object is set to the same as that of the camera coordinate system of the first image (r_{1,1}=(1, 0, 0)^{T}, r_{2,1}=(0, 1, 0)^{T}). The coordinates of all n points in m images are arranged as elements of a matrix D, then the following equation is obtained.

$$D = MS$$

$$where$$

$$D = ( \begin{matrix}{x}_{1}^{1} & … & {x}_{i}^{1} & … & {x}_{n}^{1} \\ … & … & … & … & … \\ {x}_{1}^{j} & … & {x}_{i}^{j} & … & {x}_{n}^{j} \\ … & … & … & … & … \\ {x}_{1}^{m} & … & {x}_{i}^{m} & … & {x}_{n}^{m} \\ {y}_{1}^{1} & … & {y}_{i}^{1} & … & {y}_{n}^{1} \\ … & … & … & … & … \\ {y}_{1}^{j} & … & {y}_{i}^{j} & … & {y}_{n}^{j} \\ … & … & … & … & … \\ {y}_{1}^{m} & … & {y}_{i}^{m} & … & {y}_{n}^{m}\end{matrix} ) , \\ M = ( \begin{matrix}{s}_{1} {r}_{1 , 1}^{T} \\ … \\ {s}_{j} {r}_{1 , j}^{T} \\ … \\ {s}_{m} {r}_{1 , m}^{T} \\ {s}_{1} {r}_{2 , 1}^{T} \\ … \\ {s}_{j} {r}_{2 , j}^{T} \\ … \\ {s}_{m} {r}_{2 , m}^{T}\end{matrix} ) , \\ and$$

$$S = ( \begin{matrix}{X}_{1} & … & {X}_{i} & … & {X}_{n} \\ {Y}_{1} & … & {Y}_{i} & … & {Y}_{n} \\ {Z}_{1} & … & {Z}_{i} & … & {Z}_{n}\end{matrix} ) .$$

The shapes of M and S show that the rank of D is 3. In this example, in step 5001, the matrix D has been given. Hereinafter, the rotation data M and the shape S are obtained.

The singular value decomposition of the matrix D, D=UΣV^{T}, is considered. In the equation, Σ is a matrix in which singular values are arranged in size order on the diagonal line, and U and V are respectively the left orthogonal matrix and the right orthogonal matrix. The above-described method can be used for this singular value decomposition. More specifically, in the singular value decomposition apparatus 1, if the matrix A stored in the matrix storage portion 11 is taken as the matrix D, singular value decomposition on the matrix A is performed as described above. Herein, in the singular value decomposition apparatus 1, the singular vectors of the upper bidiagonal matrix B obtained by transforming the matrix D are stored in the singular vector storage portion 20, and thus the singular vectors have to be transformed into singular vectors of the matrix D as described above.

Herein, three or more non-zero singular values are obtained due to digital errors of the images. However, the fourth and subsequent singular values are generated due to noise, and are extremely smaller than the first three singular values. Thus, in step S5002, singular vectors are calculated for the first three singular values. Three vectors used herein are represented as follows.

D′=L′Σ′R′^{T}=M′S′

where M′=L′(Σ′)^{1/2}, S′=(Σ′)^{1/2}R′^{T}, and D′ are a rank 3 matrix that minimizes ∥D-D′∥.

Next, M and S are to be obtained using D′. However, the number of the combination is not limited to one. The reason for this is that an arbitrary regular matrix C satisfies D′=(M′C)(C⁻¹S′). Thus, C in this equation is obtained such that M=M′C is satisfied. C satisfies the following equation.

$$\begin{matrix}{MM}^{T} = {M}^{′} {CC}^{T} {M}^{′ T} \\ = ( \begin{matrix}1 & … & … & 0 & … & … \\ ⋮ & ⋱ & ⋮ & ⋮ & ⋱ & ⋮ \\ … & … & {s}_{m}^{2} & … & … & 0 \\ 0 & … & … & 1 & … & … \\ ⋮ & ⋱ & ⋮ & ⋮ & ⋱ & ⋮ \\ … & … & 0 & … & … & {s}_{m}^{2}\end{matrix} )\end{matrix}$$

If E=CC^{T}, 2m+1 linear equations relating to six elements of E are obtained using this equation. Since m≧3, the elements of E can be uniquely determined. In step S5003, the matrix E is obtained.

Next, in step S5004, C is obtained using E. The degree (9) of freedom of C is higher than the degree (6) of freedom of E. Thus, C can be determined by adding the condition r₁ⱼ=(1, 0, 0)^{T}, r₂ⱼ=(0, 1, 0)^{T}. At that time, two solutions (Necker Reversal) are obtained.

Next, in step S5005, the rotation data M and the shape S are determined using M=M′C and S=C⁻¹S′.

[Application to Document Search]

Next, a case will be described in which singular value decomposition is applied to document search. Terms associated with the contents of documents are extracted from the documents, and the weights of the terms are calculated. Then, in a vector space model, the documents are represented as vectors whose elements are the weights of the terms. Herein, documents that are to be searched for are taken as d₁, d₂, . . . , dₙ, and it is assumed that there are m terms w₁, w₂, . . . , wₘ in total throughout the entire document group. At that time, a document dⱼ is represented as the following vector. This vector is referred to as a document vector.

$${d}_{j} = ( \begin{matrix}{d}_{1 j} \\ {d}_{2 j} \\ ⋮ \\ {d}_{mj}\end{matrix} )$$

In the equation, dᵢⱼ is the weight of a term wᵢ in the document dⱼ. Furthermore, the entire document group can be represented as an m×n matrix D as follows.

$$\begin{matrix}D = ( \begin{matrix}{d}_{1} & {d}_{2} & … & {d}_{n}\end{matrix} ) \\ = ( \begin{matrix}{d}_{11} & {d}_{12} & … & {d}_{1 n} \\ {d}_{21} & {d}_{22} & … & {d}_{2 n} \\ ⋮ & ⋮ & ⋱ & ⋮ \\ {d}_{m 1} & {d}_{m 2} & … & {d}_{mn}\end{matrix} )\end{matrix}$$

The matrix D is referred to as a term-document matrix. Each column of the term-document matrix is a document vector that represents information relating to the document. In a similar manner, each row of the term-document matrix is a vector that represents information relating to the term, and is referred to as a term vector. As in the case of the documents, a search query also can be represented as a vector whose elements are the weights of the terms. If the weight of a term wᵢ contained in a search query sentence is taken as qᵢ, a search query vector q is represented as follows.

$$q = ( \begin{matrix}{q}_{1} \\ {q}_{2} \\ ⋮ \\ {q}_{m}\end{matrix} )$$

In actual document search, a document similar to a given search query sentence has to be found. This process is performed by calculating the similarity between the search query vector q and each of the document vectors dⱼ. Various methods for determining the similarity between vectors are conceivable, but cosine measure (the angle between two vectors) or inner product is frequently used in document search.

$$\begin{matrix}cos ( {d}_{j} , q ) = \frac{{d}_{j} \cdot q}{‖ {d}_{j} ‖ ‖ q ‖} \\ = \frac{{\sum }_{i = 1}^{m} {d}_{ij} {q}_{i}}{\sqrt{{\sum }_{i = 1}^{m} {d}_{ij}^{2}} \sqrt{{\sum }_{i = 1}^{m} {q}_{i}^{2}}}\end{matrix}$$

### Cosine Measure

$${d}_{j} \cdot q = {\sum }_{i = 1}^{m} {d}_{ij} {q}_{i}$$

### Inner Product

Herein, if the length of the vectors is normalized to 1 (if cosine normalization is performed), the cosine measure matches the inner product.

FIG. 26 is a flowchart showing an example of a document search method using the singular value decomposition apparatus 1 according to this embodiment.

In step 6001, a query vector q is received.

In this example, search using an approximate matrix Dₖ of D is considered. In a vector space model, search is performed by calculating the similarity between the search query vector q and each of the document vectors dⱼ in the term-document matrix D, but Dₖ is used instead of D in this example. In a vector space model, the number of the dimensions of the document vectors is equal to the total number of the terms. Accordingly, as the number of documents that are to be searched for increases, the number of the dimensions of the document vectors also tends to increase. However, as the number of the dimensions increases, problems such as limitation due to a memory of a computer or an increase in search time occur. Furthermore, the noise-related influences of unnecessary terms contained in the documents lower search accuracy. Latent semantic indexing (LSI) is a technique that improves search accuracy by projecting document vectors in a high-dimensional space into a low-dimensional space. Terms separately treated in a high-dimensional space may be treated as mutually associated terms in a low-dimensional space, and thus search based on the semantics and the concepts of the terms can be performed. For example, in an ordinary vector space model, the term ‘car’ is totally different from the term ‘automobile’, and thus a query with one of the terms cannot be used in the search for a document containing the other term. However, in a low-dimensional space, it is expected that these terms semantically associated to each other are reduced to one dimension, and thus the search query ‘car’ can be used in the search not only for a document containing ‘car’ but also for a document containing ‘automobile’. In LSI, the dimensions of a high-dimensional vector is reduced by singular value decomposition. This process is basically equivalent to principal component analysis in multivariate analysis.

In step S6002, k is selected. Herein, k satisfying k<r is selected, r=min(n, m), and k may be given in advance or may be selectable in each calculation.

Next, in step S6003, singular value decomposition on a matrix D is performed. The method described above can be used in this singular value decomposition. More specifically, in the singular value decomposition apparatus 1, if the matrix A stored in the matrix storage portion 11 is taken as the matrix D, singular value decomposition on the matrix A is performed as described above. Herein, in the singular value decomposition apparatus 1, singular vectors of the upper bidiagonal matrix B obtained by transforming the matrix D are stored in the singular vector storage portion 20, and thus these singular vectors have to be transformed into singular vectors of the matrix D as described above. Furthermore, in this singular value decomposition, singular vectors of D are computed for k singular values consisting of the first to the k^{th} calculated singular values arranged in descending order by size. Herein, k is the value selected in step S6002.

More specifically, U^{k} and V^{k} satisfying Dₖ=UₖΣVₖ^{T} are calculated. Herein, Uₖ is an m×k matrix constituted only by the first k left singular vectors, Vₖ is an n×k matrix constituted only by the first k right singular vectors, and Σ is a k×k diagonal matrix constituted only by the first k singular values.

Next, in step 6004, the similarity between the matrix Dₖ and the query vector q is calculated. If a vector eⱼ is taken as a unit vector of n dimensions, the j^{th} document vector of Dₖ can be represented as Dₖeⱼ. Examples of the manner how the similarity between the document vector Dₖeⱼ and the search query vector q is calculated include, but are not limited to,

$$\begin{matrix}cos ( {D}_{k} {e}_{j} , q ) = \frac{( {D}_{k} {e}_{j} ) q}{‖ {D}_{k} {e}_{j} ‖ ‖ q ‖} \\ = \frac{{( {D}_{k} {e}_{j} )}^{T} q}{‖ {D}_{k} {e}_{j} ‖ ‖ q ‖} \\ = \frac{{( {U}_{k} {Σ}_{k} {V}_{k}^{T} {e}_{j} )}^{T} q}{‖ {U}_{k} {Σ}_{k} {V}_{k}^{T} {e}_{j} ‖ ‖ q ‖} \\ = \frac{{e}_{j}^{T} {V}_{k} {Σ}_{k} {U}_{k}^{T} q}{‖ {Σ}_{k} {V}_{k}^{T} {e}_{j} ‖ ‖ q ‖} \\ = \frac{{( {Σ}_{k} {V}_{k}^{T} {e}_{j} )}^{T} ( {U}_{k}^{T} q )}{‖ {Σ}_{k} {V}_{k}^{T} {e}_{j} ‖ ‖ q ‖} .\end{matrix}$$

This equation shows that Dₖ does not have to be rebuilt based on Uₖ, Σₖ, and Vₖ, and that the similarity can be directly calculated using a result of the singular value decomposition. In this equation, ΣₖVₖ^{T}eⱼ can be rewritten as ΣₖVₖ^{T}eⱼ=Uₖ^{T}Dₖeⱼ. The right side of this equation represents the coordinates of the j^{th} document vector in the approximate matrix Dₖ under the basis Uₖ (representation of the document in k dimensions). In a similar manner, Uₖ^{T}q in the equation shown above refers to the coordinates of the search query vector q under the basis Uₖ (representation of the search query in k dimensions)

In step S6005, a result of the search using the similarity calculated in step S6004 as a reference is output.

Lastly, performance evaluation according to numerical experiments will be described. In this example, the method using the singular value decomposition apparatus 1 according to this embodiment, standard D&C, and QR with shift are compared. DBDSDC provided in LAPACK was used as D&C. DBDSQR provided in LAPACK was used as QR. The LAPACK used in the experiments calls BLAS (Basic Linear Algebra Subprograms) optimized with ATLAS (Automatically Tuned Linear Algebra Software). In the singular value decomposition portion 15 in the singular value decomposition apparatus 1 according to this embodiment, singular value decomposition was performed using QR. Opteron 1.8 GHz with cache memories L1D: 64 KB, L1I: 64 KB, and L2: 1024 KB was used as the calculating machine.

FIG. 27 is a table showing calculation time. It is shown that singular value decomposition using the singular value decomposition apparatus 1 can be performed at a speed much higher than those using the other singular value decomposition methods. In particular, the comparison with D&C shows the effect obtained by omitting vector update.

FIG. 28 is a table showing a change in the calculation time between different matrix sizes. It is shown that singular value decomposition using the singular value decomposition apparatus 1 has a calculation amount of approximately O(n²).

Herein, in the measurement of the calculation time shown in FIGS. 27 and 28, calculation was performed on a matrix whose diagonal elements are 2.001 and non-diagonal elements are 2.0, and that has no adjacent singular value.

FIG. 29 is a table showing calculation accuracy. It is shown that computation of singular values using the singular value decomposition apparatus 1 has high accuracy as in D&C. In FIG. 29, accuracy was evaluated in the process of solving 100 random matrices. The matrix size was 1000.

As described above, in the singular value decomposition apparatus 1 according to this embodiment, only singular values are computed using D&C. Accordingly, vector update, which is performed in standard D&C, does not have to be performed, and thus the processing can be performed at a speed much higher than standard D&C. Furthermore, the process of computing singular vectors based on the singular values also can be performed at high speed. Moreover, the singular value decomposition apparatus 1 according to this embodiment has substantially high parallelism in both of the step of computing singular values and the step of computing singular vectors based on the singular values, although it is difficult to perform the step of computing singular values in parallel in QR. Furthermore, it is shown that the accuracy obtained using the singular value decomposition apparatus 1 according to this embodiment is approximately the same as those obtained using D&C or QR.

Herein, the singular value decomposition apparatus 1 according to this embodiment may be a stand-alone apparatus, may be a server apparatus in a server-client system, or may be a system constituted by multiple apparatuses as described above. If the singular value decomposition apparatus 1 is a server apparatus in a server-client system, the matrix A stored in the matrix storage portion 11, singular values stored in the singular value storage portion 18, singular vectors stored in the singular vector storage portion 20, and the like may be exchanged via a communication line such as the Internet or an intranet.

Furthermore, a part of the processes in the singular value decomposition apparatus 1 may be performed outside the singular value decomposition apparatus 1. For example, the process of the matrix dividing portion 14 dividing the bidiagonal matrix B or the process of the singular value decomposition portion 15 performing singular value decomposition may be not performed in the singular value decomposition apparatus 1. In this case, for example, each of the bidiagonal matrices whose size is equal to or smaller than a predetermined size, obtained by dividing the bidiagonal matrix B, may be accepted via an input device, a communication line, a storage medium, or the like, and stored in the diagonal matrix storage portion 13. Furthermore, for example, singular values of each of the bidiagonal matrices and matrix elements, which are a part of elements of left and right orthogonal matrices constituted by singular vectors of each of the bidiagonal matrices, may be accepted via an input device, a communication line, a storage medium, or the like, and stored in the singular value decomposition storage portion 16, the singular values and the singular vectors being obtained by performing singular value decomposition on each of the bidiagonal matrices whose size is equal to or smaller than the predetermined size.

Furthermore, in the foregoing embodiments, each processing or each function may be realized by integrated processing by a single apparatus or a single system, or alternatively, may be realized by distributed processing by multiple apparatuses or multiple systems.

Furthermore, in the foregoing embodiments, each constituent element may be constituted by dedicated hardware, or alternatively, constituent elements that can be realized as software may be realized by executing a program. For example, each constituent element may be realized by a program execution portion such as a CPU reading out and executing a software program stored in a storage medium such as a hard disk or a semiconductor memory. Herein, the software that realizes the singular value decomposition apparatus in the foregoing embodiments may be a following program. Specifically, this program is a program for causing a computer to execute: a singular value computing step of reading out singular values and matrix elements of each of bidiagonal matrices, from a singular value decomposition storage portion in which the singular values of each of the bidiagonal matrices and the matrix elements, which are a part of elements of left and right orthogonal matrices constituted by singular vectors of each of the bidiagonal matrices, are stored, the singular values and the singular vectors being obtained by dividing a bidiagonal matrix B into two bidiagonal matrices, repeating the process of dividing the bidiagonal matrix into two bidiagonal matrices until the size of each of the bidiagonal matrices after the division becomes not greater than a predetermined size, and performing singular value decomposition on each of the bidiagonal matrices whose size is not greater than the predetermined size, computing singular values of the bidiagonal matrix that is the division origin and matrix elements of the bidiagonal matrix that is the division origin based on the singular values and the matrix elements and storing the computed singular values and matrix elements in the singular value decomposition storage portion, repeating the process of computing singular values and matrix elements of the bidiagonal matrix that is the division origin, until at least one singular value of the bidiagonal matrix B is computed, and storing the at least one singular value of the bidiagonal matrix B in a singular value storage portion; and a singular vector computing step of reading out the bidiagonal matrix B from a diagonal matrix storage portion in which the bidiagonal matrix B is stored, reading out the singular value of the bidiagonal matrix B from the singular value storage portion, computing at least one singular vector of the bidiagonal matrix B based on the bidiagonal matrix B and the singular value thereof using twisted factorization, and storing the computed singular vector in a singular vector storage portion. Furthermore, in this program, the computer may be caused to further execute a singular value decomposition step of reading out each of the bidiagonal matrices whose size is not greater than the predetermined size, from the diagonal matrix storage portion in which each of the bidiagonal matrices whose size is not greater than the predetermined size is also stored, performing singular value decomposition on each of the bidiagonal matrices so as to compute singular values of each of the bidiagonal matrices and singular vectors of each of the bidiagonal matrices, and storing the singular values and matrix elements, which are a part of elements of left and right orthogonal matrices constituted by the singular vectors, in the singular value decomposition storage portion.

Furthermore, the software that realizes the singular value decomposition apparatus in the foregoing embodiments may be a following program. Specifically, this program is a program for causing a computer to execute: a matrix dividing step of reading out a bidiagonal matrix B from a diagonal matrix storage portion in which the bidiagonal matrix B is stored, dividing the bidiagonal matrix B into two bidiagonal matrices and storing the two bidiagonal matrices in the diagonal matrix storage portion, and repeating the process of dividing the bidiagonal matrix into two bidiagonal matrices and storing the two bidiagonal matrices in the diagonal matrix storage portion until the size of each of the bidiagonal matrices after the division becomes not greater than a predetermined size; a singular value decomposition step of reading out each of the bidiagonal matrices whose size is not greater than the predetermined size from the diagonal matrix storage portion, performing singular value decomposition on each of the bidiagonal matrices so as to compute singular values of each of the bidiagonal matrices and singular vectors of each of the bidiagonal matrices, and storing the singular values obtained by the singular value decomposition and matrix elements, which are a part of elements of left and right orthogonal matrices constituted by the singular vectors, in a singular value decomposition storage portion; a singular value computing step of reading out the singular values and the matrix elements of each of the bidiagonal matrices from the singular value decomposition storage portion, computing singular values of the bidiagonal matrix that is the division origin and matrix elements of the bidiagonal matrix that is the division origin based on the singular values and the matrix elements and storing the computed singular values and matrix elements in the singular value decomposition storage portion, repeating the process of computing singular values and matrix elements of the bidiagonal matrix that is the division origin, until at least one singular value of the bidiagonal matrix B is computed, and storing the at least one singular value of the bidiagonal matrix B in a singular value storage portion; and a singular vector computing step of reading out the bidiagonal matrix B from the diagonal matrix storage portion, reading out the singular value of the bidiagonal matrix B from the singular value storage portion, computing at least one singular vector of the bidiagonal matrix B based on the bidiagonal matrix B and the singular value thereof using twisted factorization, and storing the computed singular vector in a singular vector storage portion.

Furthermore, in this program, the singular vector computing step may further comprises: a Cholesky decomposition step of reading out the bidiagonal matrix B from the diagonal matrix storage portion, reading out the singular value of the bidiagonal matrix B from the singular value storage portion, and performing Cholesky decomposition on the bidiagonal matrix B into an upper bidiagonal matrix B⁽⁺¹⁾ and a lower bidiagonal matrix B⁽⁻¹⁾ by performing Miura transformation, dLVv-type transformation, and inverse Miura transformation on each element of the bidiagonal matrix B; a first singular vector computing step of computing a singular vector constituting one of left and right orthogonal matrices using each element of the upper bidiagonal matrix B⁽⁺¹⁾ and the lower bidiagonal matrix B⁽⁻¹⁾ and the singular value of the bidiagonal matrix B, and storing the computed singular vector in the singular vector storage portion; and a second singular vector computing step of computing a singular vector constituting the other of the left and right orthogonal matrices using the singular vector constituting one of the left and right orthogonal matrices computed in the first singular vector computing step, the singular value of the bidiagonal matrix B, and the bidiagonal matrix B, and storing the computed singular vector in the singular vector storage portion.

It should be noted that in this program, for example, in the process of storing information, a process that can be performed only with hardware is not at least included.

Furthermore, this program may be executed by downloading from a server or the like, or may be executed by reading out a program stored on a given storage medium (e.g., an optical disk such as a CD-ROM, a magnetic disk, a semiconductor memory, etc.).

Furthermore, the computer that executes this program may be a single computer or multiple computers. More specifically, centralized processing or distributed processing may be performed.

FIG. 30 is a schematic diagram showing an example of the external appearance of a computer that executes the above-described program to realize the singular value decomposition apparatus 1 in the foregoing embodiments. The foregoing embodiments can be realized by computer hardware and a computer program executed thereon.

In FIG. 30, a computer system 100 includes a computer 101 including a CD-ROM (compact disk read only memory) drive 105 and an FD (flexible disk) drive 106, a keyboard 102, a mouse 103, and a monitor 104.

FIG. 31 is a diagram showing the computer system. In FIG. 31, the computer 101 includes, not only the CD-ROM drive 105 and the FD drive 106, but also a CPU (central processing unit) 111, a ROM (read only memory) 112 in which a program such as a startup program is to be stored, a RAM (random access memory) 113 that is connected to the CPU 111, and in which a command of an application program is temporarily stored, and a temporary storage area is provided, a hard disk 114 in which an application program, a system program, and data are stored, and a bus 115 that connects the CPU 111, the ROM 112, and the like. Herein, the computer 101 may include a network card (not shown) for providing a connection to a LAN.

The program for causing the computer system 100 to execute the functions of the singular value decomposition apparatus 1 in the foregoing embodiments may be stored in a CD-ROM 121 or an FD 122, inserted into the CD-ROM drive 105 or the FD drive 106, and transmitted to the hard disk 114. Alternatively, the program may be transmitted to the computer 101 via a network (not shown) and stored in the hard disk 114. At the time of execution, the program is loaded into the RAM 113. The program may be loaded from the CD-ROM 121 or the FD 122, or directly from a network.

Furthermore, the matrix storage portion 11, the diagonal matrix storage portion 13, the singular value decomposition storage portion 16, the singular value storage portion 18, and the singular vector storage portion 20 may be realized as the RAM 113 or the hard disk 114.

The program does not necessarily have to include, for example, an operating system (OS) or a third party program for causing the computer 101 to execute the functions of the singular value decomposition apparatus 1 in the foregoing embodiments. The program may only include a command portion to call an appropriate function (module) in a controlled mode and obtain desired results. The manner in which the computer system 100 operations is well known, and thus a detailed description thereof has been omitted.

The present invention is not limited to the embodiments set forth herein. Various modifications are possible within the scope of the present invention.

In the description above, only some of typical embodiments of the present invention were described in detail. It will be apparent to those skilled in the art that many modifications can be made to the typical embodiments without substantially departing from the merits of the present invention and the novel technique. Accordingly, all of these modifications are within the scope of the present invention.

### INDUSTRIAL APPLICABILITY

As described above, the singular value decomposition apparatus and the like according to the present invention can perform singular value decomposition at high speed, and thus this apparatus and the like are useful, for example, in apparatuses that perform image processing, search processing, and other processing using singular value decomposition.

### BRIEF DESCRIPTION OF THE DRAWINGS

FIG. 1 is a block diagram showing the configuration of a singular value decomposition apparatus according to Embodiment 1 of the present invention.

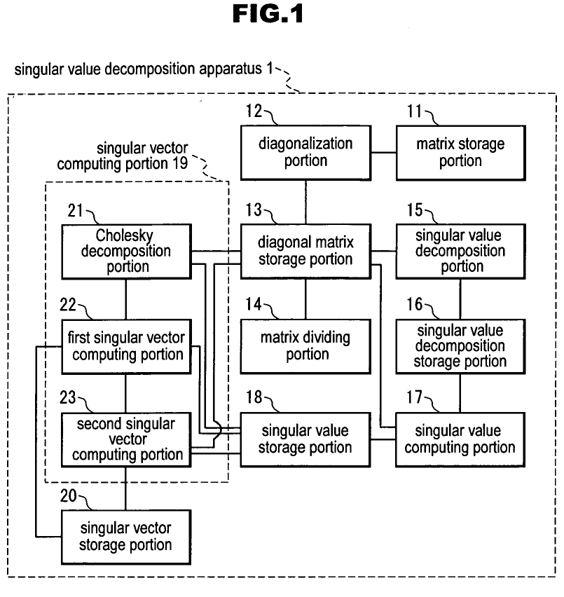

FIG. 2 is a flowchart showing the operation of the singular value decomposition apparatus according to this embodiment.

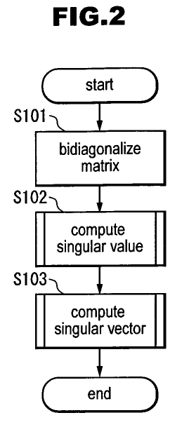

FIG. 3 is a flowchart showing the operation of the singular value decomposition apparatus according to this embodiment.

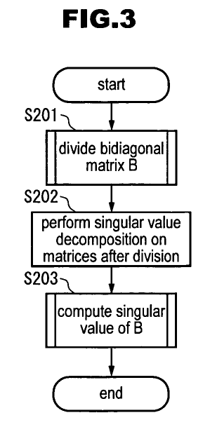

FIG. 4 is a flowchart showing the operation of the singular value decomposition apparatus according to this embodiment.

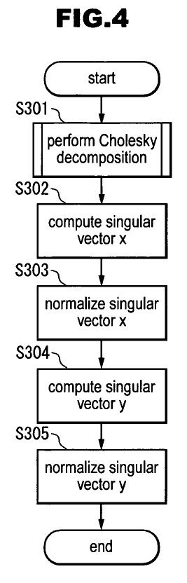

FIG. 5 is a flowchart showing the operation of the singular value decomposition apparatus according to this embodiment.

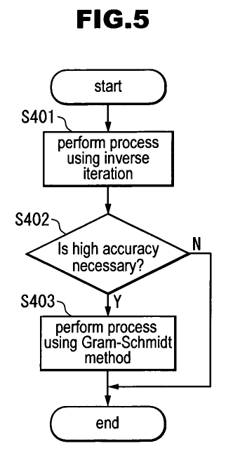

FIG. 6 is a diagram for illustrating a process of dividing an upper bidiagonal matrix B according to this embodiment.

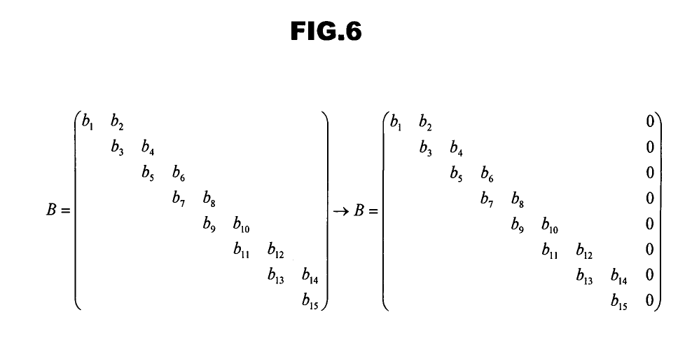

FIG. 7 is a diagram for illustrating a process of dividing the upper bidiagonal matrix B according to this embodiment.

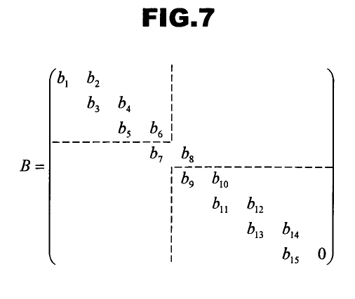

FIG. 8 is a flowchart showing the operation of the singular value decomposition apparatus according to this embodiment.

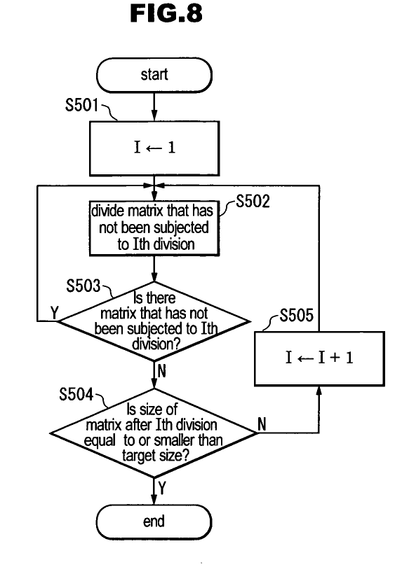

FIG. 9 is a diagram for illustrating a process of dividing the upper bidiagonal matrix B according to this embodiment.

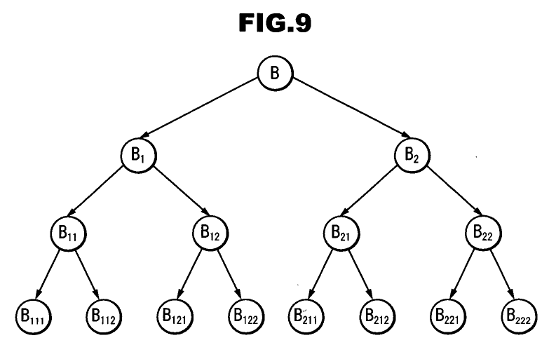

FIG. 10 is a diagram for illustrating a process of computing singular values of the upper bidiagonal matrix B according to this embodiment.

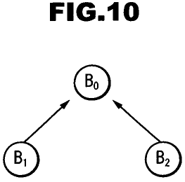

FIG. 11 is a flowchart showing the operation of the singular value decomposition apparatus according to this embodiment.

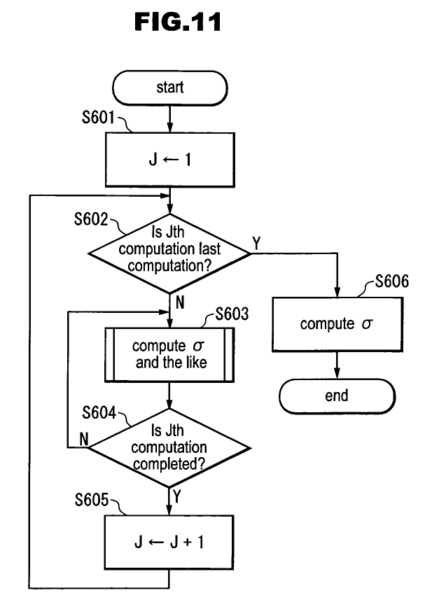

FIG. 12 is a flowchart showing the operation of the singular value decomposition apparatus according to this embodiment.

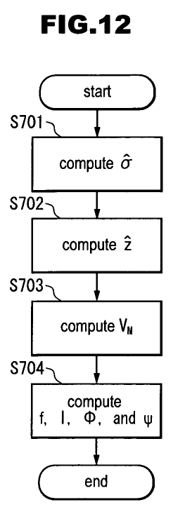

FIG. 13 is a diagram for illustrating a process of computing singular values of the upper bidiagonal matrix B according to this embodiment.

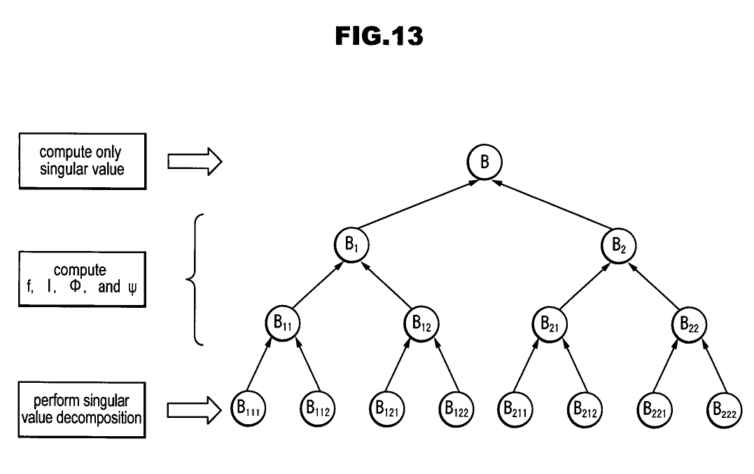

FIG. 14 is a diagram for illustrating Cholesky decomposition according to this embodiment.

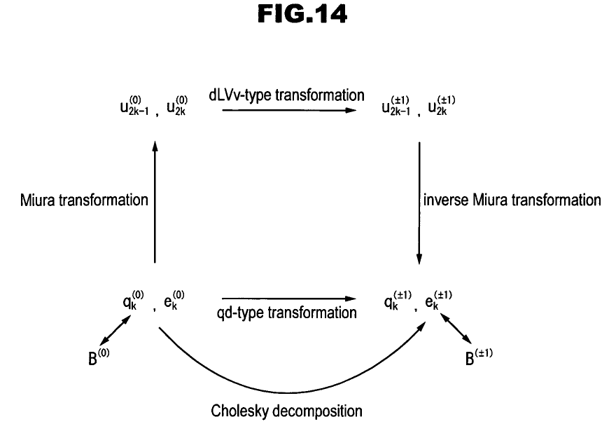

FIG. 15 is a flowchart showing the operation of the singular value decomposition apparatus according to this embodiment.

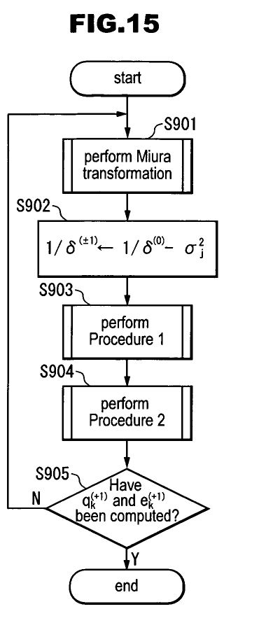

FIG. 16 is a flowchart showing the operation of the singular value decomposition apparatus according to this embodiment.

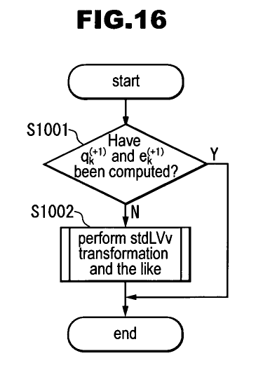

FIG. 17 is a flowchart showing the operation of the singular value decomposition apparatus according to this embodiment.

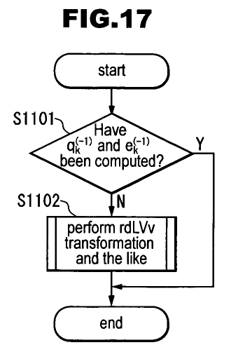

FIG. 18 is a flowchart showing the operation of the singular value decomposition apparatus according to this embodiment.

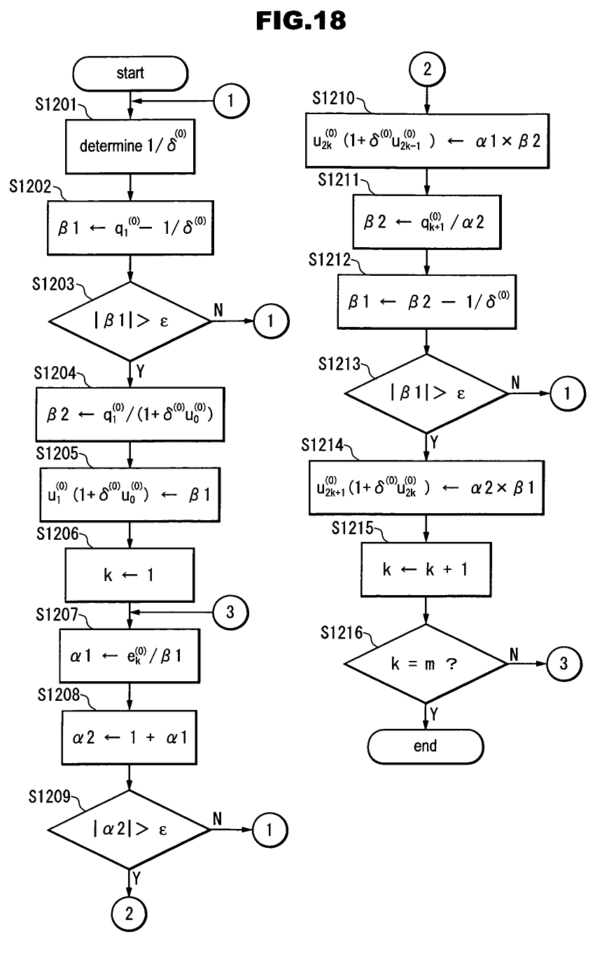

FIG. 19 is a flowchart showing the operation of the singular value decomposition apparatus according to this embodiment.

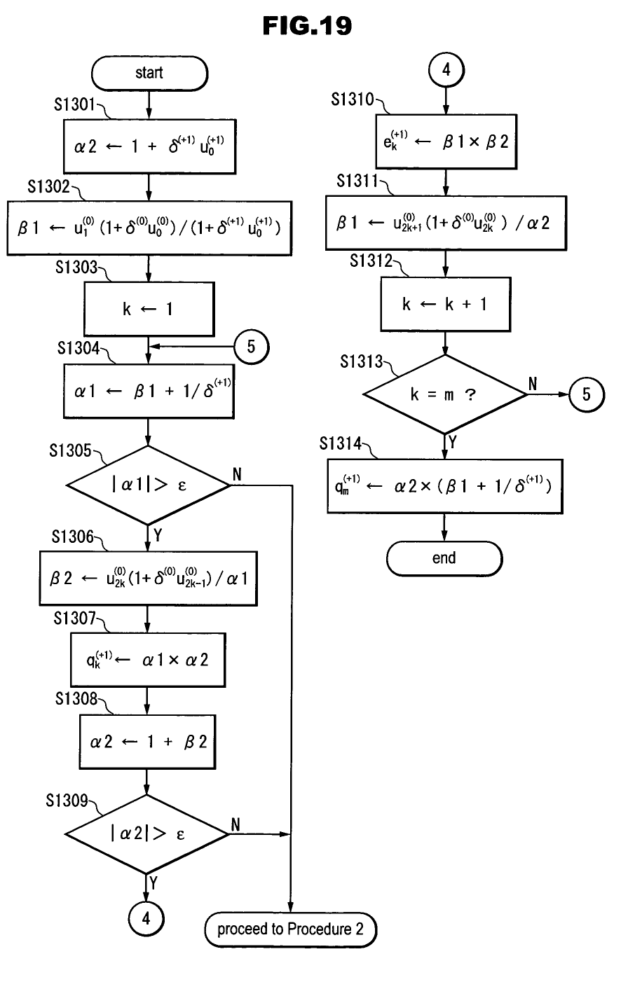

FIG. 20 is a flowchart showing the operation of the singular value decomposition apparatus according to this embodiment.

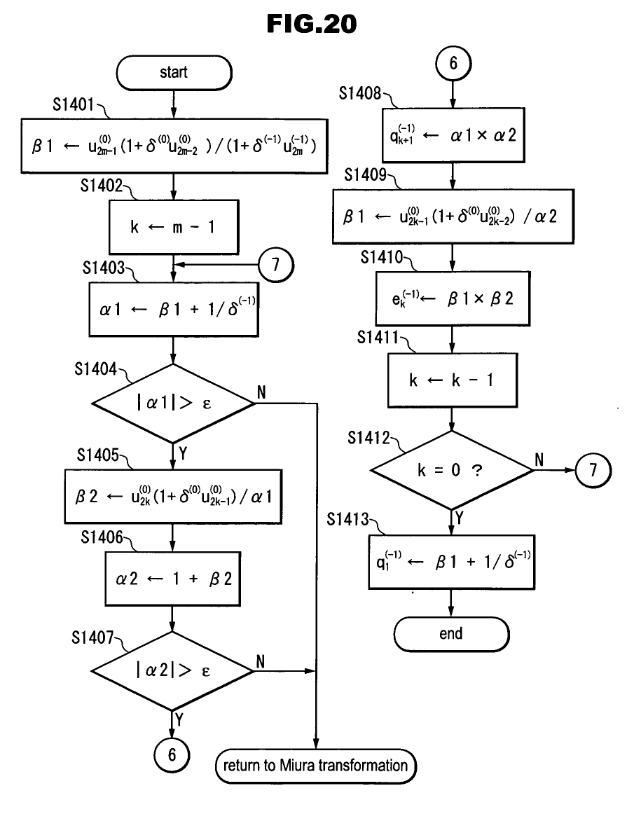

FIG. 21A is a diagram for illustrating qd-type twisted factorization according to this embodiment.

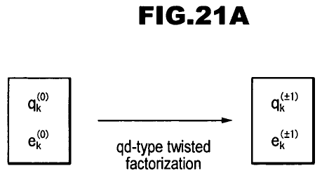

FIG. 21B is a diagram for illustrating LV-type twisted factorization according to this embodiment.

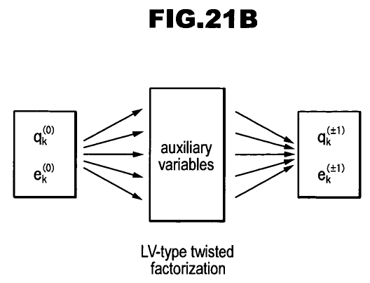

FIG. 22 is a flowchart showing the operation of the singular value decomposition apparatus according to this embodiment.

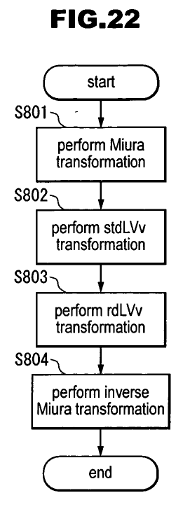

FIG. 23 is a block diagram showing another example of the configuration of the singular value decomposition apparatus according to this embodiment.

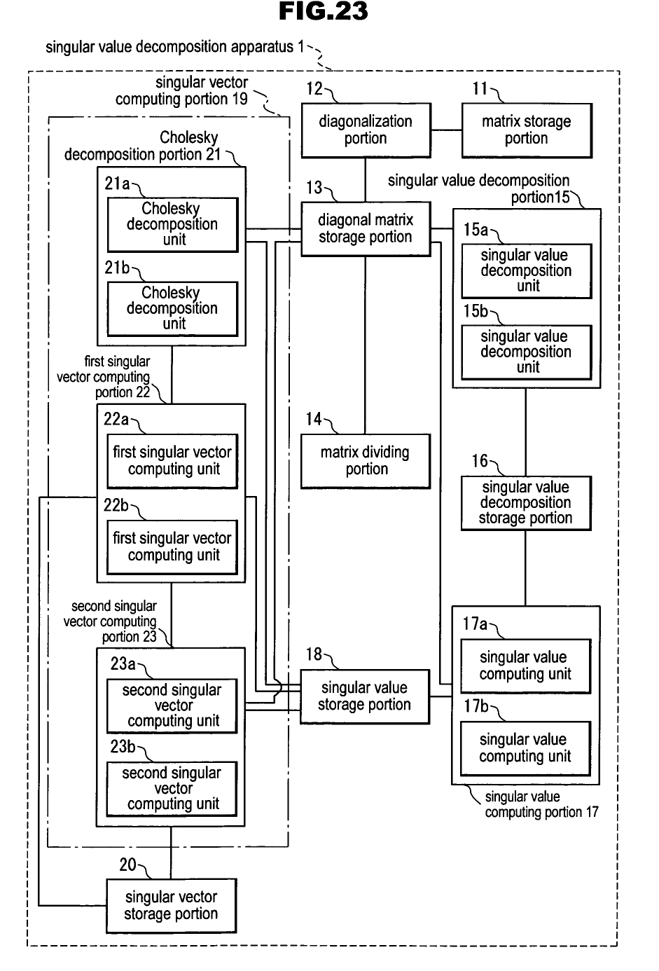

FIG. 24 is a block diagram showing another example of the configuration of the singular value decomposition apparatus according to this embodiment.

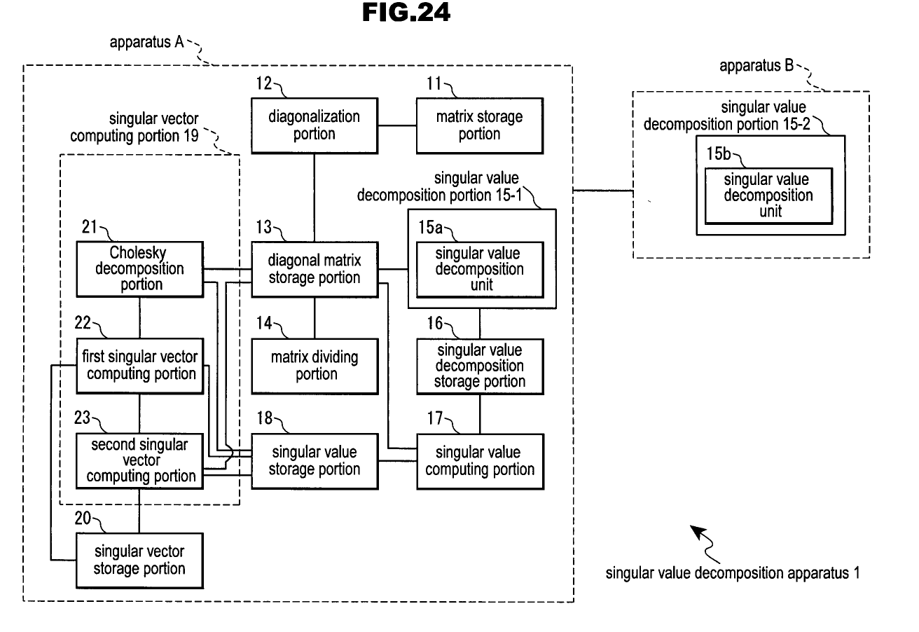

FIG. 25 is a flowchart showing an example of image processing according to this embodiment.

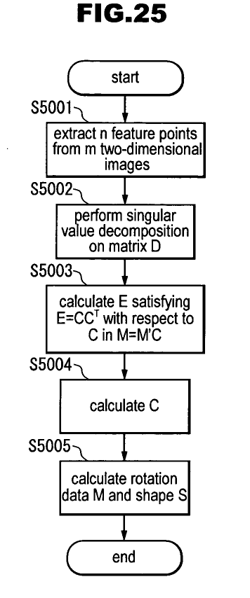

FIG. 26 is a flowchart showing an example of document search according to this embodiment.

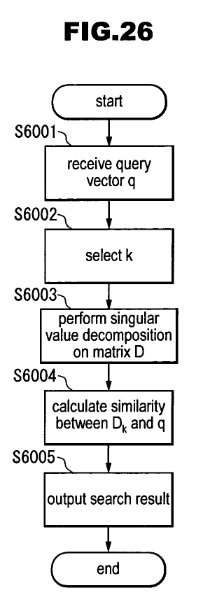

FIG. 27 is a table for illustrating a comparison between the singular value decomposition according to this embodiment and conventional singular value decomposition.

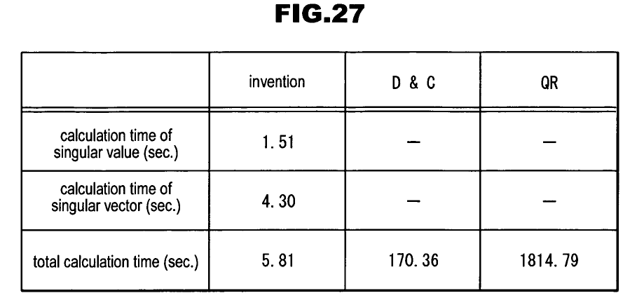

FIG. 28 is a table for illustrating a comparison between the singular value decomposition according to this embodiment and conventional singular value decomposition.

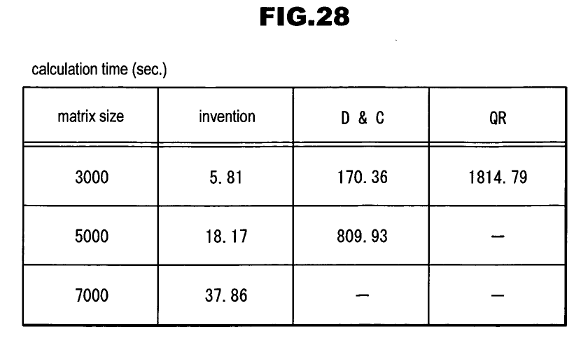

FIG. 29 is a table for illustrating a comparison between the singular value decomposition according to this embodiment and conventional singular value decomposition.

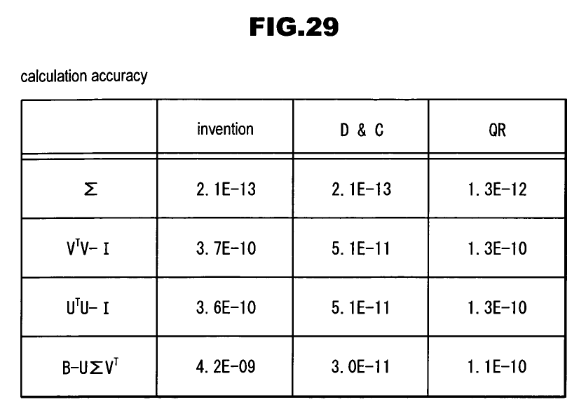

FIG. 30 is a schematic diagram showing an example of the external appearance of a computer system according to this embodiment.

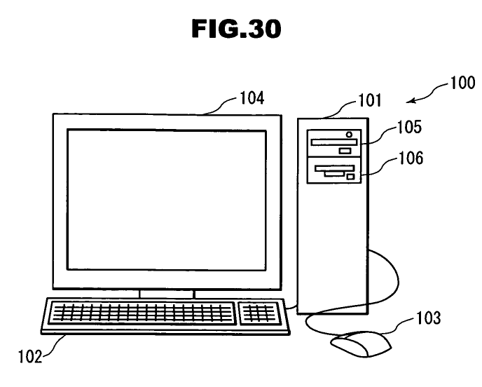

FIG. 31 is a diagram showing an example of the configuration of the computer system according to this embodiment.

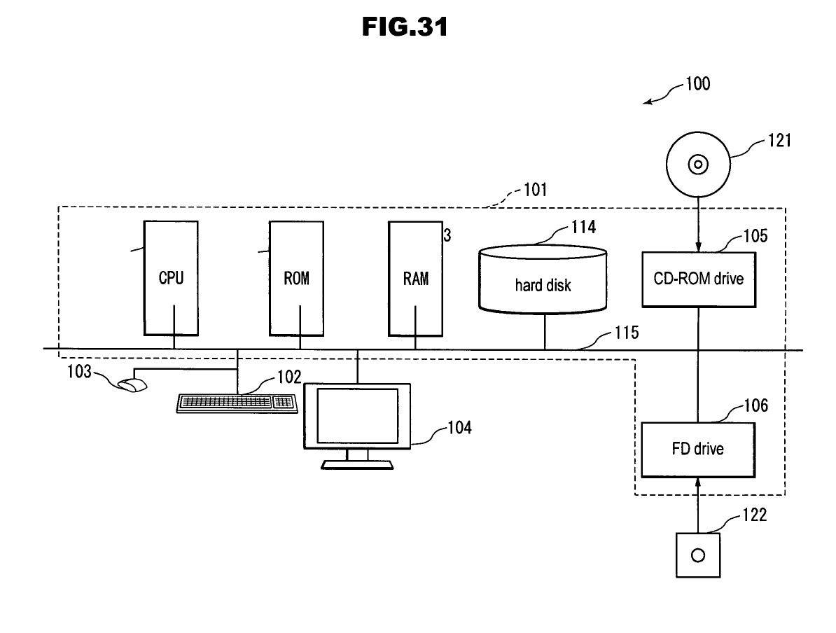

1. A singular value decomposition apparatus, comprising:
a diagonal matrix storage portion in which a bidiagonal matrix B is stored;
a singular value decomposition storage portion in which singular values of each of bidiagonal matrices and matrix elements, which are a part of elements of left and right orthogonal matrices constituted by singular vectors of each of the bidiagonal matrices, are stored, the singular values and the singular vectors being obtained by dividing the bidiagonal matrix B into two bidiagonal matrices, repeating the process of dividing the bidiagonal matrix into two bidiagonal matrices until the size of each of the bidiagonal matrices after the division becomes not greater than a predetermined size, and performing singular value decomposition on each of the bidiagonal matrices whose size is not greater than the predetermined size;
a singular value storage portion in which a singular value of the bidiagonal matrix B is stored;
a singular value computing portion that reads out the singular values and the matrix elements of each of the bidiagonal matrices from the singular value decomposition storage portion, computes singular values of the bidiagonal matrix that is the division origin and matrix elements of the bidiagonal matrix that is the division origin based on the singular values and the matrix elements and stores the computed singular values and matrix elements in the singular value decomposition storage portion, repeats the process of computing singular values and matrix elements of the bidiagonal matrix that is the division origin, until at least one singular value of the bidiagonal matrix B is computed, and stores the at least one singular value of the bidiagonal matrix B in the singular value storage portion;
a singular vector storage portion in which a singular vector of the bidiagonal matrix B is stored; and
a singular vector computing portion that reads out the bidiagonal matrix B from the diagonal matrix storage portion, reads out the singular value of the bidiagonal matrix B from the singular value storage portion, computes at least one singular vector of the bidiagonal matrix B based on the bidiagonal matrix B and the singular value thereof using twisted factorization, and stores the computed singular vector in the singular vector storage portion.

2. The singular value decomposition apparatus according to claim 1,
wherein each of the bidiagonal matrices whose size is not greater than the predetermined size is also stored in the diagonal matrix storage portion, and
the singular value decomposition apparatus further comprises a singular value decomposition portion that reads out each of the bidiagonal matrices whose size is not greater than the predetermined size from the diagonal matrix storage portion, performs singular value decomposition on each of the bidiagonal matrices so as to compute singular values of each of the bidiagonal matrices and singular vectors of each of the bidiagonal matrices, and stores the singular values and matrix elements, which are a part of elements of left and right orthogonal matrices constituted by the singular vectors, in the singular value decomposition storage portion.

3. A singular value decomposition apparatus, comprising:
a diagonal matrix storage portion in which a bidiagonal matrix B is stored;
a matrix dividing portion that reads out the bidiagonal matrix B from the diagonal matrix storage portion, divides the bidiagonal matrix B into two bidiagonal matrices and stores the two bidiagonal matrices in the diagonal matrix storage portion, and repeats the process of dividing the bidiagonal matrix into two bidiagonal matrices and storing the two bidiagonal matrices in the diagonal matrix storage portion until the size of each of the bidiagonal matrices after the division becomes not greater than a predetermined size;
a singular value decomposition portion that reads out each of the bidiagonal matrices whose size is not greater than the predetermined size from the diagonal matrix storage portion, and performs singular value decomposition on each of the bidiagonal matrices so as to compute singular values of each of the bidiagonal matrices and singular vectors of each of the bidiagonal matrices;
a singular value decomposition storage portion in which the singular values and matrix elements, which are a part of elements of left and right orthogonal matrices constituted by the singular vectors, are stored, the singular values and the singular vectors being obtained by the singular value decomposition portion performing singular value decomposition;
a singular value storage portion in which a singular value of the bidiagonal matrix B is stored;
a singular value computing portion that reads out the singular values and the matrix elements of each of the bidiagonal matrices from the singular value decomposition storage portion, computes singular values of the bidiagonal matrix that is the division origin and matrix elements of the bidiagonal matrix that is the division origin based on the singular values and the matrix elements and stores the computed singular values and matrix elements in the singular value decomposition storage portion, repeats the process of computing singular values and matrix elements of the bidiagonal matrix that is the division origin, until at least one singular value of the bidiagonal matrix B is computed, and stores the at least one singular value of the bidiagonal matrix B in the singular value storage portion;
a singular vector storage portion in which a singular vector of the bidiagonal matrix B is stored; and
a singular vector computing portion that reads out the bidiagonal matrix B from the diagonal matrix storage portion, reads out the singular value of the bidiagonal matrix B from the singular value storage portion, computes at least one singular vector of the bidiagonal matrix B based on the bidiagonal matrix B and the singular value thereof using twisted factorization, and stores the computed singular vector in the singular vector storage portion.

4. The singular value decomposition apparatus according to claim 3, wherein the singular vector computing portion computes a singular vector using qd-type twisted factorization.

5. The singular value decomposition apparatus according to claim 3, wherein the singular vector computing portion computes a singular vector using LV-type twisted factorization.

6. The singular value decomposition apparatus according to claim 5, wherein the singular vector computing portion further comprises:
a Cholesky decomposition portion that reads out the bidiagonal matrix B from the diagonal matrix storage portion, reads out the singular value of the bidiagonal matrix B from the singular value storage portion, and performs Cholesky decomposition on the bidiagonal matrix B into an upper bidiagonal matrix B⁽⁺¹⁾ and a lower bidiagonal matrix B⁽⁻¹⁾ by performing Miura transformation, dLVv-type transformation, and inverse Miura transformation on each element of the bidiagonal matrix B;
a first singular vector computing portion that computes a singular vector constituting one of left and right orthogonal matrices, using each element of the upper bidiagonal matrix B⁽⁺¹⁾ and the lower bidiagonal matrix B⁽⁻¹⁾ and the singular value of the bidiagonal matrix B, and stores the computed singular vector in the singular vector storage portion; and
a second singular vector computing portion that computes a singular vector constituting the other of the left and right orthogonal matrices, using the singular vector constituting one of the left and right orthogonal matrices computed by the first singular vector computing portion, the singular value of the bidiagonal matrix B, and the bidiagonal matrix B, and stores the computed singular vector in the singular vector storage portion.

7. The singular value decomposition apparatus according to claim 6,
wherein the Cholesky decomposition portion comprises multiple Cholesky decomposition units, and
the multiple Cholesky decomposition units perform, in parallel, the process of performing Cholesky decomposition on the bidiagonal matrix B.

8. The singular value decomposition apparatus according to claim 6,
wherein the first singular vector computing portion comprises multiple first singular vector computing units, and
the multiple first singular vector computing units perform, in parallel, the process of computing a singular vector.

9. The singular value decomposition apparatus according to claim 6,
wherein the second singular vector computing portion comprises multiple second singular vector computing units, and
the multiple second singular vector computing units perform, in parallel, the process of computing a singular vector.

10. The singular value decomposition apparatus according to claim 3,
wherein the singular value computing portion comprises multiple singular value computing units, and
the multiple singular value computing units perform, in parallel, the process of computing singular values and matrix elements of a bidiagonal matrix that is a division origin.

11. The singular value decomposition apparatus according to claim 3,
wherein the singular value decomposition portion comprises multiple singular value decomposition units, and
the multiple singular value decomposition units perform, in parallel, the process of performing singular value decomposition on a bidiagonal matrix.

12. The singular value decomposition apparatus according to claim 3, further comprising:
a matrix storage portion in which a matrix A is stored; and
a diagonalization portion that reads out the matrix A from the matrix storage portion, computes the bidiagonal matrix B in which the matrix A is bidiagonalized, and stores the bidiagonal matrix B in the diagonal matrix storage portion.

13. The singular value decomposition apparatus according to claim 3, wherein the matrix dividing portion divides a bidiagonal matrix into two substantially half bidiagonal matrices.

14. The singular value decomposition apparatus according to claim 3, wherein the singular value computing portion computes all singular values of the bidiagonal matrix B.

15. The singular value decomposition apparatus according to claim 14, wherein the singular vector computing portion computes all singular vectors of the bidiagonal matrix B.

16. The singular value decomposition apparatus according to claim 12, wherein the matrix A is a matrix constituted by the coordinates (xᵢ^{j}, yᵢ^{j}) of feature points i (i=1, . . . , n, n is an integer of 2 or more) extracted from two-dimensional images j (j=1, . . . , m, m is an integer of 3 or more).

17. The singular value decomposition apparatus according to claim 12, wherein the matrix A is a term-document matrix whose columns are represented as vectors d₁, . . . , dₙ (n is an integer of 2 or more), the vectors having the weight of terms as elements and representing documents that are to be searched for.

18. A singular value decomposition method used in a singular value decomposition apparatus that comprises a diagonal matrix storage portion in which a bidiagonal matrix B is stored, a singular value decomposition storage portion in which singular values of each of bidiagonal matrices and matrix elements, which are a part of elements of left and right orthogonal matrices constituted by singular vectors of each of the bidiagonal matrices, are stored, the singular values and the singular vectors being obtained by dividing the bidiagonal matrix B into two bidiagonal matrices, repeating the process of dividing the bidiagonal matrix into two bidiagonal matrices until the size of each of the bidiagonal matrices after the division becomes not greater than a predetermined size, and performing singular value decomposition on each of the bidiagonal matrices whose size is not greater than the predetermined size, a singular value storage portion in which a singular value of the bidiagonal matrix B is stored, a singular value computing portion, a singular vector storage portion in which a singular vector of the bidiagonal matrix B is stored, and a singular vector computing portion, comprising:
a singular value computing step using the singular value computing portion, of reading out the singular values and the matrix elements of each of the bidiagonal matrices from the singular value decomposition storage portion, computing singular values of the bidiagonal matrix that is the division origin and matrix elements of the bidiagonal matrix that is the division origin based on the singular values and the matrix elements and storing the computed singular values and matrix elements in the singular value decomposition storage portion, repeating the process of computing singular values and matrix elements of the bidiagonal matrix that is the division origin, until at least one singular value of the bidiagonal matrix B is computed, and storing the at least one singular value of the bidiagonal matrix B in the singular value storage portion; and
a singular vector computing step using the singular vector computing portion, of reading out the bidiagonal matrix B from the diagonal matrix storage portion, reading out the singular value of the bidiagonal matrix B from the singular value storage portion, computing at least one singular vector of the bidiagonal matrix B based on the bidiagonal matrix B and the singular value thereof using twisted factorization, and storing the computed singular vector in the singular vector storage portion.

19. A singular value decomposition method used in a singular value decomposition apparatus that comprises a diagonal matrix storage portion in which a bidiagonal matrix B is stored, a matrix dividing portion, a singular value decomposition portion, a singular value decomposition storage portion in which singular values and matrix elements, which are a part of elements of left and right orthogonal matrices constituted by singular vectors, are stored, the singular values and the singular vectors being obtained by the singular value decomposition portion performing singular value decomposition, a singular value storage portion in which a singular value of the bidiagonal matrix B is stored, a singular value computing portion, a singular vector storage portion in which a singular vector of the bidiagonal matrix B is stored, and a singular vector computing portion, comprising:
a matrix dividing step using the matrix dividing portion, of reading out the bidiagonal matrix B from the diagonal matrix storage portion, dividing the bidiagonal matrix B into two bidiagonal matrices and storing the two bidiagonal matrices in the diagonal matrix storage portion, and repeating the process of dividing the bidiagonal matrix into two bidiagonal matrices and storing the two bidiagonal matrices in the diagonal matrix storage portion until the size of each of the bidiagonal matrices after the division becomes not greater than a predetermined size;
a singular value decomposition step using the singular value decomposition portion, of reading out each of the bidiagonal matrices whose size is not greater than the predetermined size from the diagonal matrix storage portion, and performing singular value decomposition on each of the bidiagonal matrices so as to compute singular values of each of the bidiagonal matrices and singular vectors of each of the bidiagonal matrices;
a singular value computing step using the singular value computing portion, of reading out the singular values and the matrix elements of each of the bidiagonal matrices from the singular value decomposition storage portion, computing singular values of the bidiagonal matrix that is the division origin and matrix elements of the bidiagonal matrix that is the division origin based on the singular values and the matrix elements and storing the computed singular values and matrix elements in the singular value decomposition storage portion, repeating the process of computing singular values and matrix elements of the bidiagonal matrix that is the division origin, until at least one singular value of the bidiagonal matrix B is computed, and storing the at least one singular value of the bidiagonal matrix B in the singular value storage portion; and
a singular vector computing step using the singular vector computing portion, of reading out the bidiagonal matrix B from the diagonal matrix storage portion, reading out the singular value of the bidiagonal matrix B from the singular value storage portion, computing at least one singular vector of the bidiagonal matrix B based on the bidiagonal matrix B and the singular value thereof using twisted factorization, and storing the computed singular vector in the singular vector storage portion.

20. The singular value decomposition method according to claim 19,
wherein the singular vector computing portion further comprises a Cholesky decomposition portion, a first singular vector computing portion, and a second singular vector computing portion, and
the singular vector computing step further comprises:
a Cholesky decomposition step using the Cholesky decomposition portion, of reading out the bidiagonal matrix B from the diagonal matrix storage portion, reading out the singular value of the bidiagonal matrix B from the singular value storage portion, and performing Cholesky decomposition on the bidiagonal matrix B into an upper bidiagonal matrix B⁽⁺¹⁾ and a lower bidiagonal matrix B⁽⁻¹⁾ by performing Miura transformation, dLVv-type transformation, and inverse Miura transformation on each element of the bidiagonal matrix B;
a first singular vector computing step using the first singular vector computing portion, of computing a singular vector constituting one of left and right orthogonal matrices using each element of the upper bidiagonal matrix B⁽⁺¹⁾ and the lower bidiagonal matrix B⁽⁻¹⁾ and the singular value of the bidiagonal matrix B, and storing the computed singular vector in the singular vector storage portion; and
a second singular vector computing step using the second singular vector computing portion, of computing a singular vector constituting the other of the left and right orthogonal matrices using the singular vector constituting one of the left and right orthogonal matrices computed in the first singular vector computing step, the singular value of the bidiagonal matrix B, and the bidiagonal matrix B, and storing the computed singular vector in the singular vector storage portion.

21. A computer-readable storage medium storing a program for causing a computer to execute:
a singular value computing step of reading out singular values and matrix elements of each of bidiagonal matrices, from a singular value decomposition storage portion in which the singular values of each of the bidiagonal matrices and the matrix elements, which are a part of elements of left and right orthogonal matrices constituted by singular vectors of each of the bidiagonal matrices, are stored, the singular values and the singular vectors being obtained by dividing a bidiagonal matrix B into two bidiagonal matrices, repeating the process of dividing the bidiagonal matrix into two bidiagonal matrices until the size of each of the bidiagonal matrices after the division becomes not greater than a predetermined size, and performing singular value decomposition on each of the bidiagonal matrices whose size is not greater than the predetermined size, computing singular values of the bidiagonal matrix that is the division origin and matrix elements of the bidiagonal matrix that is the division origin based on the singular values and the matrix elements and storing the computed singular values and matrix elements in the singular value decomposition storage portion, repeating the process of computing singular values and matrix elements of the bidiagonal matrix that is the division origin, until at least one singular value of the bidiagonal matrix B is computed, and storing the at least one singular value of the bidiagonal matrix B in a singular value storage portion; and
a singular vector computing step of reading out the bidiagonal matrix B from a diagonal matrix storage portion in which the bidiagonal matrix B is stored, reading out the singular value of the bidiagonal matrix B from the singular value storage portion, computing at least one singular vector of the bidiagonal matrix B based on the bidiagonal matrix B and the singular value thereof using twisted factorization, and storing the computed singular vector in a singular vector storage portion.

22. A computer-readable storage medium storing a program for causing a computer to execute:
a matrix dividing step of reading out a bidiagonal matrix B from a diagonal matrix storage portion in which the bidiagonal matrix B is stored, dividing the bidiagonal matrix B into two bidiagonal matrices and storing the two bidiagonal matrices in the diagonal matrix storage portion, and repeating the process of dividing the bidiagonal matrix into two bidiagonal matrices and storing the two bidiagonal matrices in the diagonal matrix storage portion until the size of each of the bidiagonal matrices after the division becomes not greater than a predetermined size;
a singular value decomposition step of reading out each of the bidiagonal matrices whose size is not greater than the predetermined size from the diagonal matrix storage portion, performing singular value decomposition on each of the bidiagonal matrices so as to compute singular values of each of the bidiagonal matrices and singular vectors of each of the bidiagonal matrices, and storing the singular values obtained by the singular value decomposition and matrix elements, which are a part of elements of left and right orthogonal matrices constituted by the singular vectors, in a singular value decomposition storage portion;
a singular value computing step of reading out the singular values and the matrix elements of each of the bidiagonal matrices from the singular value decomposition storage portion, computing singular values of the bidiagonal matrix that is the division origin and matrix elements of the bidiagonal matrix that is the division origin based on the singular values and the matrix elements and storing the computed singular values and matrix elements in the singular value decomposition storage portion, repeating the process of computing singular values and matrix elements of the bidiagonal matrix that is the division origin, until at least one singular value of the bidiagonal matrix B is computed, and storing the at least one singular value of the bidiagonal matrix B in a singular value storage portion; and
a singular vector computing step of reading out the bidiagonal matrix B from the diagonal matrix storage portion, reading out the singular value of the bidiagonal matrix B from the singular value storage portion, computing at least one singular vector of the bidiagonal matrix B based on the bidiagonal matrix B and the singular value thereof using twisted factorization, and storing the computed singular vector in a singular vector storage portion.

23. The computer-readable storage medium program according to claim 22,
wherein the singular vector computing step further comprises:
a Cholesky decomposition step of reading out the bidiagonal matrix B from the diagonal matrix storage portion, reading out the singular value of the bidiagonal matrix B from the singular value storage portion, and performing Cholesky decomposition on the bidiagonal matrix B into an upper bidiagonal matrix B⁽⁺¹⁾ and a lower bidiagonal matrix B⁽⁻¹⁾ by performing Miura transformation, dLVv-type transformation, and inverse Miura transformation on each element of the bidiagonal matrix B;
a first singular vector computing step of computing a singular vector constituting one of left and right orthogonal matrices using each element of the upper bidiagonal matrix B⁽⁺¹⁾ and the lower bidiagonal matrix B⁽⁻¹⁾ and the singular value of the bidiagonal matrix B, and storing the computed singular vector in the singular vector storage portion; and
a second singular vector computing step of computing a singular vector constituting the other of the left and right orthogonal matrices using the singular vector constituting one of the left and right orthogonal matrices computed in the first singular vector computing step, the singular value of the bidiagonal matrix B, and the bidiagonal matrix B, and storing the computed singular vector in the singular vector storage portion.
